(19) United States
(12) Patent Application Publication
(10) Pub. No.: US 2021/0109958 A1
(43) Pub. Date: Apr. 15, 2021

(54) CONCEPTUAL, CONTEXTUAL, AND SEMANTIC-BASED RESEARCH SYSTEM AND METHOD

(71) Applicant: Stacks LLC, Raleigh, NC (US)

(72) Inventors: Alireza Behtash, Raleigh, NC (US); Behnam Kia, Raleigh, NC (US)

(21) Appl. No.: 17/069,970

(22) Filed: Oct. 14, 2020

Related U.S. Application Data
(60) Provisional application No. 62/971,069, filed on Feb. 6, 2020.
(60) Provisional application No. 62/914,669, filed on Oct. 14, 2019.

(51) Int. Cl. G06F 16/33; G06N 20/00; G06K 9/62

(52) U.S. Cl. CPC G06F 16/3347; G06N 20/00; G06Q 50/18; G06F 16/3335; G06K 9/6256

(57) ABSTRACT

Systems are described in the field of machine learning such as natural language processing for use in researching and searching a corpus of documents in various topical areas such as physical and social sciences. The systems may utilize training, testing, and deployment of models representing a defined space within the corpus. A network of computers and user input devices may be used for receiving research queries via human-computer interface devices and application programming interfaces. Queries may be processed and used as input to the machine learning models. Outputs from the models may include ranking of results reflecting the queries.

### CROSS-REFERENCE TO RELATED APPLICATIONS

This application is based on and claims the benefit of the filing dates and disclosures of U.S. Provisional Patent Application No. 62/914,669, filed Oct. 14, 2019, for “Research Tools Based on Machine Learning and Artificial Intelligence Special Application in Legal Research, Scientific Literature Research, and Patent Search,” and U.S. Provisional Patent Application No. 62/971,069, filed Feb. 6, 2020, for “Conceptual, Contextual, and Semantic-Based Research System and Method,” the contents and disclosures of which are each incorporated herein by reference in their entireties.

### BACKGROUND OF THE INVENTION

### Field of the Invention

The present invention relates to methods, apparatus, and systems, including computer programs encoded on a computer storage medium, for research tools to discover and find relevant, desired information and documents from an existing database of records. Particularly, the invention relates to, in response to a search query, returning relevant information and documents from the existing database of records.

### Description of Related Art

Artificial intelligence (AI) is the name of a field of research and techniques in which the goal is to create intelligent systems. Machine learning (ML) is an approach to achieve this goal. Deep learning (DL) is the set of latest most advanced techniques in ML.

In the legal service industry, case law, rules, regulations, ordinances, and statutes refer or relate to different laws passed by a legislative body. Case law is a set of opinions issued by courts, some of which may establish a precedent set by a court. Rules and regulations are introduced and promulgated by executive branches. Statutes are codified laws passed by legislatures. In this document, all of these are referred as “law” for simplicity. If need be, the explicit terminology will be used to mean either one.

In the United States and other common-law countries, prior judicial decisions set a precedent for future issues and cases. A challenge for legal practitioners in the legal services industry and beyond is to find relevant existing case law, rules, and statutes applicable to a circumstance, and to discover what the relevant law is based on existing precedent. Due to the sheer amount of case law, however, it is practically impossible for a person to go through all published judicial decisions to identify what laws were applied.

Legal research tools have been developed to help researchers identify applicable laws and supporting or relevant cases. These legal research systems operate on the premise that simple word-searching algorithms will match the words of the query entered by the users with the words from case law text. The system then returns a list of cases with the highest occurrences of the words from the query. The leading legal case law search tools follow this general approach. Even with the introduction of so-called “natural language search,” these research tools still break down the query into words and then try to match these words with the words found in the body of case law.

Such word-matching research tools look for the occurrence of the query words within the case law and other legal documents. This type of search is not efficient because the presence or absence of words of the query compared to the body of a document does not necessarily confirm the relevance or irrelevance of the found documents. For example, a word search might find documents that contain words but that are contextually irrelevant. Or, if the user applied a different terminology for the query that is contextually or even texturally different than the one in the documents, the word-matching process would fail to match and locate relevant text.

Furthermore, word-matching systems are limited in their capabilities. For example, with word-matching research tools, it is crucial to limit the number of words in the query presented to the system. And, all included words should be in with no extra unnecessary elaboration. But, if the user uses too many generic words, the research tool will return irrelevant documents that contain these generic words. Note that this task of choosing very few, but informative words, is not an easy task by itself, and the user needs prior knowledge of the field to complete the task. Basically, the user must know: 1) what information is significant or insignificant and therefore, should or should not be included in the search (i.e., contextualization), and 2) what the proper/accepted terminology is best for expressing the information (i.e., lexicographical textualization). If the user fails to include the important or correct terms or includes too many irrelevant details, the word-searching system fails.

For example, in legal research, the user must know the legal factors for analyzing the issue to filter out the important facts from the situation and use the correct legal terms from prior cases before even having prior cases to reference. Alternatively, the user must employ trial-and-error with different combinations of possible words to discover the correct set of keywords that leads to good results. These situations defeat the premise of using a research tool that is supposed to help the, practitioners discover what the law says about an issue. A similar conclusion can be made more broadly to scientific literature research tools or other uses of word-matching research tools.

Recently, a few new legal research tools have emerged that are designed based on the modern natural language understanding. The main idea behind these research tools is to proceed systematically through the body of all the case-related files (e.g., judicial opinions, statutes, legal opinions, etc.) in a database to look for a language in a database records (e.g., files) that shares the same meaning with the query. Such research tools are better than conventional legal research tools because they do not aim to rigidly match words of the query to the words of a case document; rather, they aim to understand the query and find similar sentences from the document.

These improved research tools face the same challenge that word-matching research tools suffer, namely overfilling, which is a technical term in data science related to when the observer reads too much into limited observations thus missing the bigger picture. The improved research tools consider and search each record of the database one at a time, independent from the rest of the records, trying to determine whether the case file contains the query or not, without paying attention to the entirety of the relevant documents and how they apply in different situations. This challenge of modern research tools manifests itself within the produced results.

For example, the results of such research tools are sensitive to the query. That is, tweaking the query in a small direction causes the results to change dramatically. The altered query may exist in a different set of case files, and therefore the results are going to be confusingly different. Moreover, since the focus of these research tools is on one document at a time, the struggle is really to combine and sort the results in terms of relevance to the query. Sorting the results is done based on how many common words exist between the query and the case file, or how similar the language of the query is to that of a case. As a result, the results run the risk of being too dependent on the details of the query and the case file, rather than concentrating on the importance of a case and its conceptual relevance to the query.

There is a new generation of legal research tools that instead of receiving a query, receive a document from the user. Such legal research tools process the uploaded document to extract the main subjects, and then perform a legal search for these subjects and returns the results. One can consider these research tools as a two-step analytical engine: in the first step, the research tool extracts the main subjects of a document with methods such as word frequency, etc.; and in the second step, the research tool performs a regular search for these subjects over the case files in the database. Such research tools suffer from the same problem of overfitting, sensitivity to the details, and lack of a universal measure for assessing the relevance and the in of laws in relation to a user's query.

What is needed, therefore, is a research system that gains some knowledge and understanding from the database of records (such as broad and specific concepts within a context of facts) and makes sense of the user's textual query to return relevant results. Such a research system would accomplish this regardless of the exact word choice and the existence of irrelevant details in or the eloquence of the query. It should be able to perform contextual analysis on the database records to find results.

What is also needed is a legal research system in which the user can include different aspects of the issue as a summary of facts or a long list of keywords. Then, the research system considers the entirety of the issue and automatically discerns the important aspects of the query while neglecting irrelevant details. Such a research system should understand the case law, statutes, and rules and where and when each applies so that it can return relevant results. A similar scenario can be supposed for a research system in scientific literature research, patent search scenarios, and so on.

What is further needed is a research system that both comprehends and understands the records of the database and the user's query. This gives rise to an educated response, including relevant information, thus expanding applications of the research system. For example, a legal research system having an understanding of the applicability of laws in terms of time and place can provide legal advice given a user's legal queries. Such a system could also operate as a virtual lawyer or a legal assistant. Today, there are virtual legal service companies that try to replace the function of lawyers, but the services are usually limited to reviewing or preparing simple standard legal documents without the ability to accommodate special needs or complex situations of their customers. As a result, their services fail whenever something deviates from the standard preprogramed practices. An improved research system can be a part of, or be expanded to become, a virtual lawyer that is able to customize legal services based on a unique situation presented for analysis. Similarly, a scientific literature research. system that comprehends the context of the scientific literature and can return relevant information for a given query may well be used as a virtual scientific advisor.

Moreover, many researchers are conducting research and publishing their findings in scientific journals. An incredibly large number of such articles have been published over the years. The producers and users of science and engineering information continually need to know what type of research has been done and what has not, or what problems have been solved and how, or what the state-of-the-art results and solutions are in a field for a problem. Of course, it is practically impossible for a person to manually read all the articles to discover the answers to these questions. As a solution to this problem, a series of literature search systems are commonly employed to automate this process, whereby a user provides a set of keywords to the system to narrow down and codify what information is needed. The research system then goes through the database of scientific articles and returns anything containing the provided keywords. What is apparent, however, is the need for a more sophisticated research tool.

In addition to the above needs, power consumption and carbon footprints are other considerations in legal and technical research systems, and thus should also be addressed. Legal research systems process big data. For example, when a user enters a query to a legal research system, the legal research system takes the query, and searches a database that can be composed of tens of millions of case files and other secondary sources (if not more), to find matches. This single search by itself requires a lot of resources in terms of memory to store the files, compute power to perform the search on a document, and communication to transfer the documents from a hard disk or a memory to the processor for processing. Even for a single search, a regular desktop computer may not perform the task in a timely manner, and therefore a high-performance server is required. Techniques such as database indexing make searching a database faster and more efficient; however, the process of indexing and retrieving information remain a complex, laborious and time-consuming process. As a result, a legal research tool needs a large data center to operate. Such data centers are expensive to purchase, setup, and maintain; they consume a lot of electricity to operate and to cool down; and they have large carbon footprint. It is estimated that data centers consume about 2% of electricity worldwide and that number could rise to 8% by 2030, and much of that electricity is produced from non-renewable sources, contributing to carbon emissions. A legal research tool can be hosted on a local data center owned by the provider of the legal research tool, or it can be hosted on the cloud. Either way, the equipment cost, operation cost, and electricity bill will be paid by the provider of the legal service one way or another. What is needed, therefore, is a more efficient research tool that only needs a small amount of resources, consumes less electricity per query, and has a smaller carbon footprint compared to existing research tools such as those discussed above.

### BRIEF SUMMARY OF THE INVENTION

The presently-described intelligent research system utilizing machine learning techniques, including the latest deep learning models and techniques, addresses the above and other needs, problems, and disadvantages exhibited by existing textual and natural language research tools.

For the sake of simplicity and to reduce redundancy, the term “ML” (machine learning) is used to cover AI, ML, and DL. The only exception to this convention would arise when the aim is to distinguish one from the rest. In such cases, the precise terminology is used.

The term “DL” refers to deep neural networks, deep neural models, DL models, or deep neural computing, and may be used interchangeably.

The term “context” is used in two different ways. First, it is used to refer to factual context for a law citation describing the reason for why the law is cited. Second, it is used to refer to linguistic context for a polysemic word.

A “user” refers to a human or another machine, software or hardware.

One aspect of the research systems described herein are their application in, but not limited to, legal research to discover case law, statutes, rules, and the like for a given issue, a set of facts, a concept, a topic, a set of words, and/or a combination of the same

Another aspect of the research systems are their application in scientific research to find prior published papers and results for a specific problem.

Still another aspect of the research systems are their application to patent research to find prior art given an invention description. Other applications are also possible and within the scope of this invention.

Another aspect involves a series of ML and DL methods for exploring and modeling a database of records, the outcome being a trained model to be used by users as a research tool.

When applied in the field of legal research, a research system, which is a model of the law, can be a part of, or expanded to become, a virtual assistant or an intelligent system to provide services to a user or other systems to solve complex problems or to perform tasks. The database of records embodies the information. A command, request, or instruction received from a user or another system in the form of voice, text, or any other type of physical or digital signal, triggers the research system to explore the database, find important information as a solution or answer to the user's query, and return the relevant information in the form of voice or text, or take an action learned from the database of records.

In another aspect, the research systems involve methods, apparatus, and subsystems, including computer programs encoded on a computer storage medium, for (1) designing and training a ML model to learn different laws and when and where they are applied, and (2) applying the trained model as a research system.

Here, a trained model could represent a court's opinion about how laws are applied to different situations. This trained model can receive the user's query as a summary of facts or a sequence of keywords, and it produces the relevant laws through the lens of the court. This model may not need to go through the entire database, nor does it need to perform an extensive search to find relevant cases containing the query entered by the user. Rather, the trained model of the research system looks at the user's query and directly returns the relevant laws based on the factual patterns in the query and what the model has learned in the training processes used to train it. This compares to conventional research tools, where for each query the research system usually performs a search across the database to find case files that contain the user's query.

A model of a court's opinions is meant to reveal that court's possible references to any legal context in response to an inquiry made by users. The model serves as an intelligent agent for empowering a human to understand the logic behind the interpretation of legal matters from a court's perspective that is otherwise impossible for a human to analyze in a reasonable period of time. This aspect of the research system provides a predictive system for predicting the likelihood of different possible outcomes of a situation. Furthermore, the system can be used as a prescriptive tool to examine different strategies in order to come up with a winning strategy in court. That is, provided with different sets of arguments or facts, the system can predict outcomes in an educated way. One advantage of the research system is its ability to provide legal practitioners and others an ability to construct their approach based on a strategy that is most likely to prevail.

Searching through all records of a database consumes a considerable amount of electrical power and increases greenhouse gas emissions. Performing a search with a regular search engine takes too much time, thus it slows the speed of the system and compromises the user's experience. Thus, in another aspect, the research system described herein involves a trained model that captures the essence of law with no extra details, and it directly returns the relevant laws based on a user's query.

In supervised ML, the goal is to learn a function that maps an input to an output based on example input-output pairs. Putting this into the context of a research system, the goal is to learn a function that receives the query from the user, map the query into the correct outputs and bring the outputs back as search results. More specifically within legal research, the purpose of supervised ML is to learn a function that responds with laws for a given issue. In ML, such functions are not hardcoded or programmed. Rather, the machine learns it from the patterns that exist between input-output example pairs referred to as a training dataset. Each pair is composed of the correct output for a given input. Having access to a good training dataset is a must for the success of any ML application.

Typically, court documents (and other documents) contain unstructured data. Such documents are not directly usable as a training dataset. For example, case law, statutes, rules, and regulations come with different citation formats and often with no explicit boundary for where a citation starts and ends.

Thus, in another aspect, spotting and extracting law citations within the text of a court opinion or other document, and determining the context for each law citation, is performed, with the result being a suitable training, dataset. More broadly, methods and systems for extracting a suitable training dataset from the database of the records, such as court opinions, scientific literature, patent files, etc., for training the ML models, are provided.

In still another aspect, designing and applying DL models and techniques that can be trained on the training dataset and used as a research system are described. As an example, in the context of legal research, after the training process is over, the trained model of the research system learns the conceptual, contextual, and related factual patterns and how different, relevant laws are applied for these patterns.

In another aspect, a trained model is deployed as a research tool. In this tool, the user explains the issue at hand using a summary of facts or a series of keywords, and the trained model returns the relevant laws based on the factual, contextual, and conceptual information and patterns in the user's query. In this scenario, there will be no searching over all court opinions to compare and match them with the query. Rather, the user can include different aspects of the issue as a summary of facts or a long list of keywords. Then, the trained model of the research system with its context-analyzing capabilities considers the entirety of the issue and automatically picks out the important legal aspects and patterns and neglects the irrelevant details. Since the research system understands semantics of the words, the exact words used to express the facts is not as important as it is in alternative tools.

In another aspect, it has been discovered that treating laws (or patents, literature articles, etc.) as continuous-valued vectors can greatly enhance the predictive power and scalability of the research system. A continuous-valued representation for each law may be used and, accordingly, the model and the training process is redesigned to predict these representations.

In still another aspect, laws can be transformed into dense, continuous-valued vectors in a low dimensional space called state space based on the contextual similarity of the laws. A context for each law is determined by looking at the locations of the citation in the court case texts. Since the transformation does preserve the contextual similarity of the legal citations by placing correlated laws close to one another in the state space, contextually similar laws end up being mapped to close-by vectors in the state space. In some embodiments, the laws may be mapped to the same state space that the words are mapped to.

In yet another aspect, the research system includes methods, apparatus, and subsystems including computer programs encoded on a computer storage medium, that involve finding excerpts similar to a query. In particular, the research system returns example excerpts for each law, showing how the law has been applied to situations similar to the one explained by a user using a query. These excerpts could be contexts in which the law was applied in the court's prior rulings. Each law may have been cited many times in different contexts, and some contexts could be legally closer to the received query than others.

Also, since the research system models the laws, it can have applications beyond a basic research system. In another aspect, it can also serve as a virtual legal advisor or assistant. As a model of a court's opinions and laws, the research system can be developed into a predictive system for predicting the likelihood of different possible outcomes given a set of facts related to a situation. The research system may be a predictive model that can be used as a simulator to examine different strategies in order to come up with a winning strategy to be in legal proceedings. Similarly, the model can be used as a foundation for predictive and prescriptive analysis for legal cases because it has learned the law and is a model for a court's interpretation of that law.

In another aspect, the research system directly shows the user where the quotes are in the original case file appear, as opposed to many existing systems that only refer the user to a secondary manipulated source.

It is important to create and maintain a clean set of law citations used in court opinions and rulings. Unfortunately, not all the citations in court cases follow the standard Bluebook format, and sometimes a law is cited in an abbreviated or a non-standard form. If this problem is not attended and corrected, the same law may appear in multiple different versions in the training dataset, which adds noise to the training dataset and reduces the performance of the trained model. Thus, in another aspect, the research system consolidates different versions of law citations into one.

If a law is not cited enough in a database, a ML model may not be properly trained to learn the factual patterns associated with that law. These lowly-cited laws are hence excluded from the training dataset and, accordingly, the trained model cannot explore and represent them. Thus, in another aspect, a method using ML to explore lowly-cited laws and return the relevant ones is provided. In some embodiments, this special ML technique for lowly-cited laws may work in conjunction with the DL models of the research system, and the results are going to be a combination of relevant laws produced by both systems. A nearest neighborhood technique, employed in the feature space that returns laws close to the query, may be used for that purpose.

By way of non-limiting examples, aspects of the system may be applied as a legal research tool that receives the users query and provides on-point laws directly; as a legal research tool that receives a law citation from the user and provides other similar important laws; as a legal complaint, brief, memorandum of law, or other pleading-type document analyzer that reads the document and, whenever and wherever observes critical legal issues and patterns, provides the relevant laws; as an add-on to a word processing application or other typesetting editors, or an add-on to internet browsers where a user can call the system by highlighting a section of a document or a page and the system will then proceed to pull up landmark laws and authorities related to that section of the document as a writing assistant with which a user can highlight a section of the document and the system finds relevant laws and excerpts from court opinions and helps the user rewrite the section in accordance with and following the courts language.

Although the above summary focuses mostly on laws, other aspects of the research system involve applications to other fields such as scientific literature research, patent search, and others.

### BRIEF DESCRIPTION OF THE DRAWINGS

FIG. 1 is a basic flow chart of research systems that are commonly used in legal, scientific literature, patent, and many other similar research systems.

FIG. 2 is an exemplary flow chart for training a ML, model to operate as a research system.

FIG. 3 is an exemplary operational flow diagram for preprocessing the documents.

FIGS. 4A and 4B are an exemplary flow chart for footnote processing.

FIG. 5 shows an exemplary, operational flow diagram to locates legal citations.

FIG. 6 shows with an example how localization and boundary detection methods for legal citation work.

FIG. 7 presents an exemplary, operational flow diagram for extracting a suitable training, dataset for legal research systems.

FIG. 8 presents an exemplary operational flow diagram for finding and extracting context for each cited law.

FIG. 9 presents an exemplary operational flow diagram for checking dependency or independency of a sentence consistent.

FIG. 10 presents an exemplary operational flow diagram for finding and extracting context for each cited law.

FIG. 11 presents an exemplary operational flow diagram for converting the training dataset to a format usable by Naïve Bayes method.

FIG. 12 shows an exemplary schematic for how a user can use this trained model as a research system.

FIG. 13 shows an exemplary flowchart for transforming dataset to be used in a deep neural network.

FIG. 14 shows an exemplary architecture for a DL model to be used as a research system.

FIG. 15 shows an exemplary flow chart for calculating word vectors from a corpus.

FIG. 16 is an exemplary diagram showing how a DL model, serving as the legal research engine, can be trained to map an input context or query submitted by a user to relevant laws.

FIG. 17 shows an exemplary diagram for calculating the loss value and updating model parameters.

FIG. 18 is an exemplary visualization showing how laws can be considered as dense, continuous-valued vectors, while preserving their contextual similarity.

FIG. 19 is an exemplary visualization showing how the output of the DL model could be a vector in a state space where laws are represented as contextually-aware vectors.

FIG. 20 shows an exemplary low chart for transforming the training dataset into a ML friendly format in which the legal citations are transformed into continuous-valued vectors.

FIG. 21 shows an exemplary architecture for a DL model to be used as a research system that treats laws as continuous-valued vectors.

FIG. 22 shows an exemplary flow chart for training a ML model with augmented data to operate as a research system.

FIG. 23 is an exemplary flow chart showing how the training dataset can be augmented.

FIG. 24 shows an exemplary architecture for a DL model to be used as a research system with a noise layer included.

FIG. 25 shows an exemplary multi-branch convolutional neural network with an embedding layer and a fully connected feedforward neural network to be used as a research system.

FIG. 25 shows an exemplary bidirectional RNN neural network with attention layer, an embedding layer and a fully connected feedforward neural network to be used as a research system.

FIG. 27 shows an exemplary attention layer on top of a bidirectional RNN network.

FIG. 28 shows an exemplary BERT model that is trained on the training dataset and can be used as a research system.

FIG. 29 shows an exemplary architecture to be used as a research system, which is composed of an ensemble of trained ML models.

FIG. 30 is a screenshot from an exemplary system showing different components of the search results page.

FIG. 31 for a screenshot of as an exemplary implementation for the spellchecking method.

FIG. 32 shows an exemplary flow chart to transform the user's query into a format untestable by the ML models.

FIG. 33 is an exemplary embodiment showing an implemented system for the presentation of model results.

FIG. 34 shows an exemplary visualization for how to find experts close to the user's query.

FIG. 35 is an exemplary, step-by-step flow chart for finding similar example excerpts.

FIG. 36 is a diagram of an exemplary user interface corresponding to one or more embodiments of the invention.

FIG. 37 shows an exemplary, step-by-step flow chart for consolidating contextually and lexically similar laws.

FIG. 38 shows an exemplary flow chart for how model-free ML technique may find relevant, but lowly cited laws.

FIG. 39 flow chart shows an exemplary flow chart for how contextual similarity between the user's query and a law's context may be calculated.

FIG. 40 shows a screenshot from an exemplary implementation of the search.

FIG. 41 shows an exemplary flow chart for how contextual similarity between the user's query and the context of a legal citation may be calculated given different weights to the words based on their importance.

FIG. 42 shows an exemplary research system that receives a law from the user and returns laws similar to it.

FIG. 43 shows a screenshot from an exemplary implementation of the front end where the user types in the input field a legal citation, and a list is automatically dropped down to help the user find the citation in Bluebook format.

FIG. 44 shows an exemplary flow for how the content of drop-down list in FIG. 43 are prepared.

FIG. 45 shows an exemplary interface implementation, where laws similar to the user's input legal citation are listed.

FIG. 46 depicts a schematic illustration of a research system for an end-to-end ML system trained over all the documents of the database that receives a query from the user, runs a contextually-aware analysis of the query, extracts important patterns, and finally responds to the user with context-aware results.

FIG. 47 shows an exemplary flow for how a brief may be analyzed using the disclosed methods in this invention.

FIG. 48 shows an exemplary interface implementation, where an uploaded brief is analyzed and important factual patterns are highlighted.

FIG. 49 shows an exemplary plot, suggesting that the performance of a research system operating based on a trained DL model improves as the amount of the data used to train the model increases.

### DETAILED DESCRIPTION OF THE INVENTION

The drawings herein are primarily for illustrative purposes and are not intended to limit the scope or field of the invention. The embodiments describe below involve exemplary applications, and are also not intended to limit the scope or field of the invention.

### Preprocessing and Data Extraction

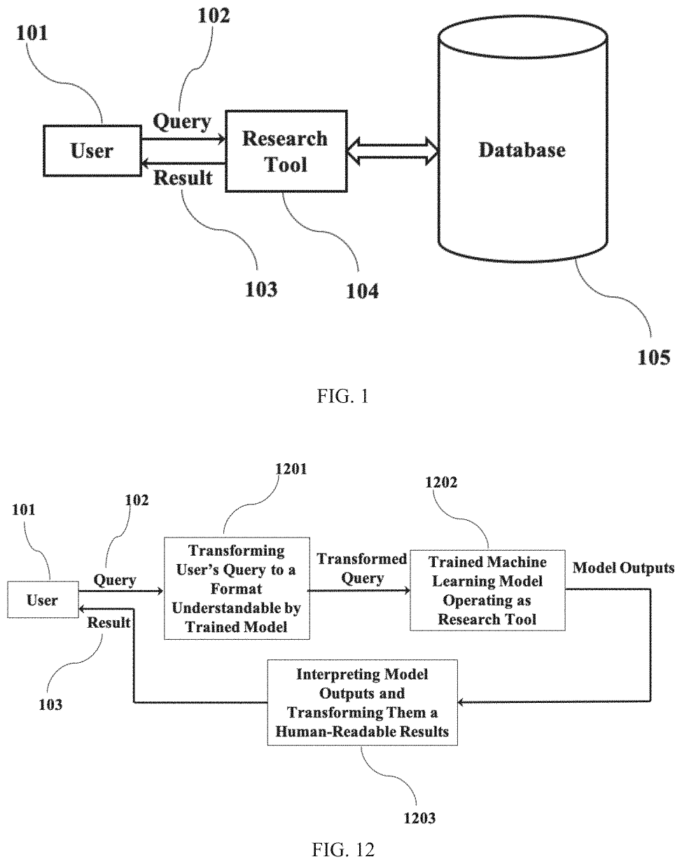

FIG. 1 presents an operational flow showing a user 101; a research system 104, also known as search tool; and a database of records 105. The research system 104 receives a query entered by the user 101 and returns the relevant information from the database 105.

The research system 104 is based on ML. This ML powered tool is trained over all the records of the database 105, has learned important concepts and in from the records, and is ready to be utilized by the user 101.

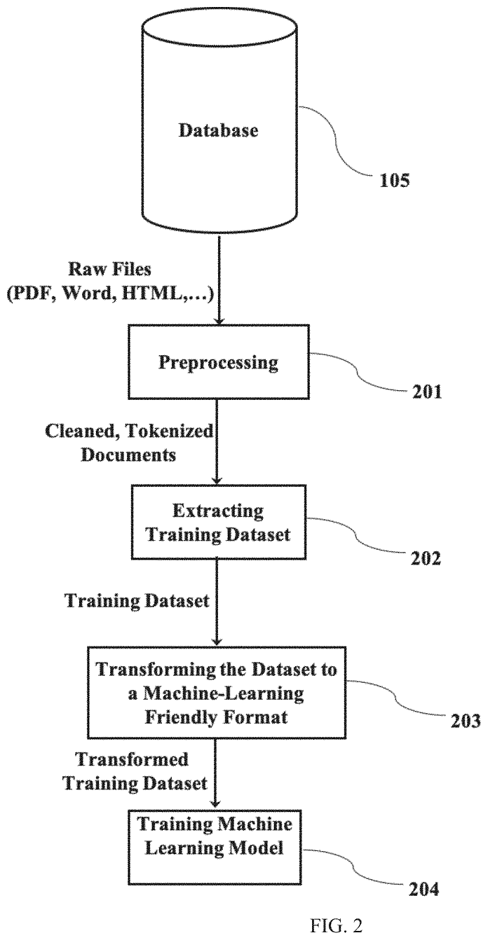

FIG. 2 presents an exemplary operational flow diagram for preparing a training dataset and for training a ML model.

The records of the database 105 are usually raw text files in PDF, word, HTML, or other text file formats. As an example, in the context of legal research, each record in the database 105 can be a court case file in PDF format. Such formats are suitable for human reading but are not ideal for computer processing. They contain extra data encoding the layout of the pages, which bears no valuable information about the context itself.

At step 201, these records are preprocessed. Preprocessing includes a combination of systematic efforts to download, extract, and clean the data, which aims to take a file from the database 105 and extract the bare data. This requires a set of automation scripts and some minimal human intervention.

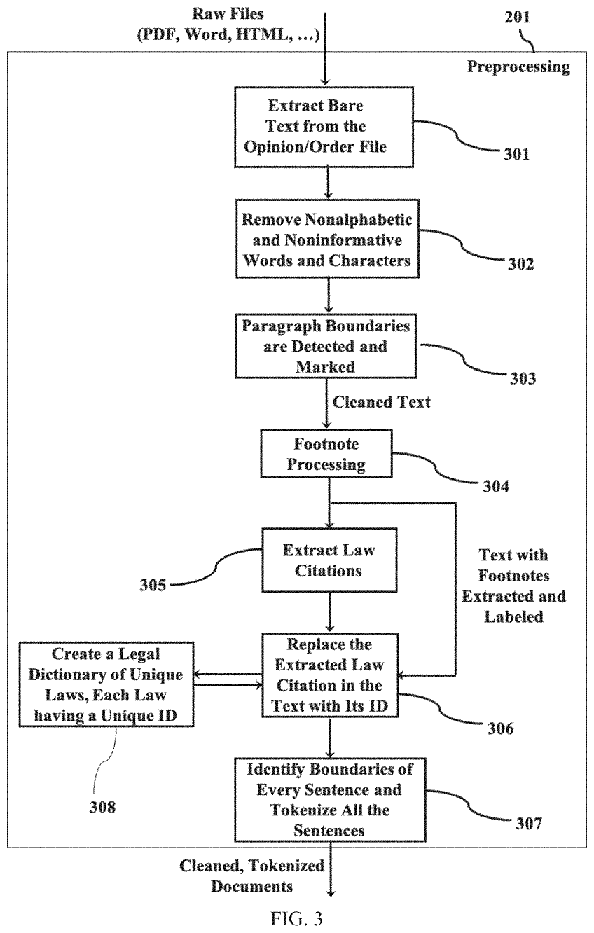

FIG. 3 presents an exemplary operational flow diagram for preprocessing the documents. The essence of the preprocessing is very similar for different types of data and documents, but the details of preprocessing depends on the type of data and documents in the database 105.

FIG. 3 shows the preprocessing flow diagram of court opinions/orders in PDF or HTML format. Step 301 involves receiving the PDF or HTML file of the court opinion/order, extracting its text, and saving the text in a file with a txt extension. The result serves as the raw data.

At step 302 the raw data are taken, nonalphabetic characters are converted to English characters and the noninformative details that would not have any legal implications or learning value are removed. This standardization causes the database 105 to be uniform across the board for better yield and a higher learning impact factor in its entirety.

At step 302 various precautions are taken to not modify or confuse the elements of the legal references with noninformative details. This step is essential because the legal references constitute what need to be extracted for learning purposes.

Step 303 in FIG. 3 deals with the task of identifying the paragraphs and labeling them. Paragraphs are the largest coherent division of words on a page that carry enough significant information to allow for meaningful context analysis. Therefore, it is crucial to make sure the system has them labeled properly and universally. To do so, the main thing to consider is the creation of a generic boundary detection formula to correctly identify where a paragraph starts and where it ends. The accuracy of these formulas is very much dependent on the typesetting style used to prepare the PDF file. If this step of defining the paragraphs is successful, the logic built into the system in 303 will calculate the boundaries of the paragraphs. This formula contains several atomic operators that roughly measure:
How distinct two lines are;
If there is any right or left, indentation, margin, or padding; and
If there are any specific characters at the beginning of a new sentence.
Once detected, these boundaries get marked automatically.

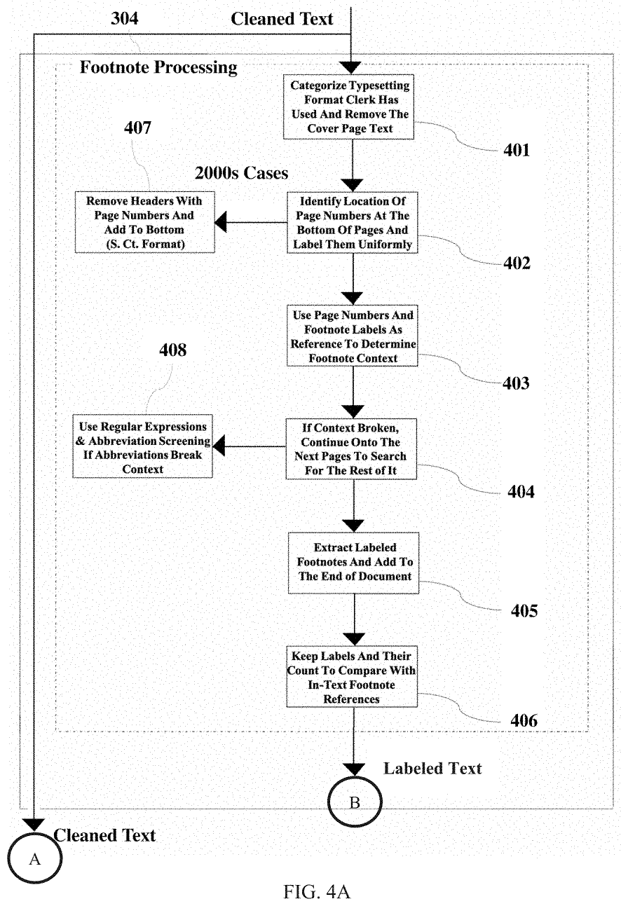

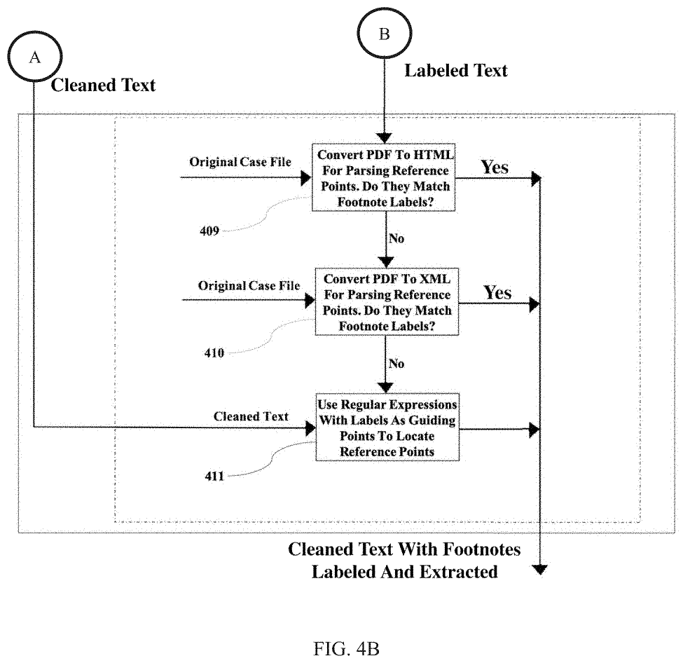

At step 304, the output of step 303 are taken, and footnotes within the cleaned text are processed. An exemplary flow chart for footnote processing, is shown in FIGS. 4A and FIG. 4B.

The process in FIGS. 4A and 4B aims to extract footnotes from the rest of the context while keeping the flow of text intact and inserting unique reference points within the text where each footnote is cited. To understand what should be identified as a footnote in an extracted PDF file, it is necessary to first determine the typesetting style of the court opinion that the clerk has used to put together the original PDF file.

At step 401, the file is categorized based on certain elements that are specific to that edition of the court file in the year it was put out. This could be any generic Unicode character or set of characters that the text converter has provided to ensure that the system will follow a series of operations unique to the specific typesetting style. Note that the date references are not good identifiers, in general, but could be used where helpful.

Also, included Step 401 is the procedure for removing the text from the first page(s) involving the names of the parties involved, etc. which are not useful information for the training purposes in the current application.

At step 402, the page numbers are identified and labeled universally in the same format. There are sometimes case files in which the page numbers appear in the header. These files are typeset in the non-machine-friendly style used by Supreme Court of the United States. At step 407, this unfavorable style is put in a machine-readable format with the least amount of contextual overhead possible by refining non-usable ‘interrupting’ text. This includes (but not limited to) removing the header and adding a labeled page number to the bottom of the page.

In step 403, the case text with page numbers marked appropriately is deposited into a boundary calculator. The right boundary of footnotes usually ends at a page number. A special piece of code activates to calculate the left boundary that is identified using either a number or asterisk (*).

If a paragraph's boundary extends from one page onto the next, steps 408 and 404 explain how the system knows to search the next page for the termination of the boundary. The system either looks for the word “(Continued)” or the word that comes immediately before the page number. If the last word on the page does not have a period following it, the system looks fur the rest of the sentence on the next page. One subtlety is that if the word has a period following it, the word might be an abbreviation. An abbreviation would not end the paragraph and would therefore be an inaccurate right boundary. Hence, a supplementary piece of code screens the word for all possible legal abbreviations. If this word is a legal abbreviation, the logic would go on to search for the rest of the footnote. Otherwise, it would stop at that word.

At step 405, the labeled footnotes are extracted and added to the end of the document.

At step 406, the extracted footnote labels are extracted and stored.

Part of the context of a legal document may be expressed in a footnote. To be able to actually make use of the context of every footnote, one needs to embed the footnotes back into the bulk of the case text from which they are cited. This is accomplished with the number or asterisk identifying the footnote found in the text. To find this needle in the haystack of words and numbers, a series of operations are performed.

Step 409 provides the first check to locate the in-text reference point of a footnote. This first check involves the PDF file hyperlinking the footnote as a superscript in the bulk. Then, the PDF file is converted to HTML. The system then looks for anything between the tags <sup></sup>. It then matches the number to those collected in the list obtained in step 410.

If the two do not match, step 410 is triggered, and the PDF file is transformed into an XML data file, and a similar logic in step 409 is followed. With the XML file, the footnote labels are matched against those labels found in 406. If a complete match exists, the process is complete.

If a match does not exist, step 411 activates a regular expression parser that looks into the cleaned text on the page where a footnote is located for the footnote number. The process in step 411 is riskier, so 409 or 410 are implemented first. Then 411 outputs a clean version of the text file that is going to be given to a tokenizer to look for legal references. It is important to note that no single method by itself is perfect and that is why three different methods have been introduced to automatically check for the maximum yield in the process of locating, the in-text references.

In legal research, laws are the most fundamental building blocks of the system. Any brief order, or opinion is based on laws, and the relevant laws are cited within the case for support. It is difficult to programmatically access citations from case records because these records are not uniformly formatted. For these records, there are no specific uniform boundary symbols indicating where a citation starts and where it ends. Step 305 in FIG. 3 performs the task of locating legal citations.

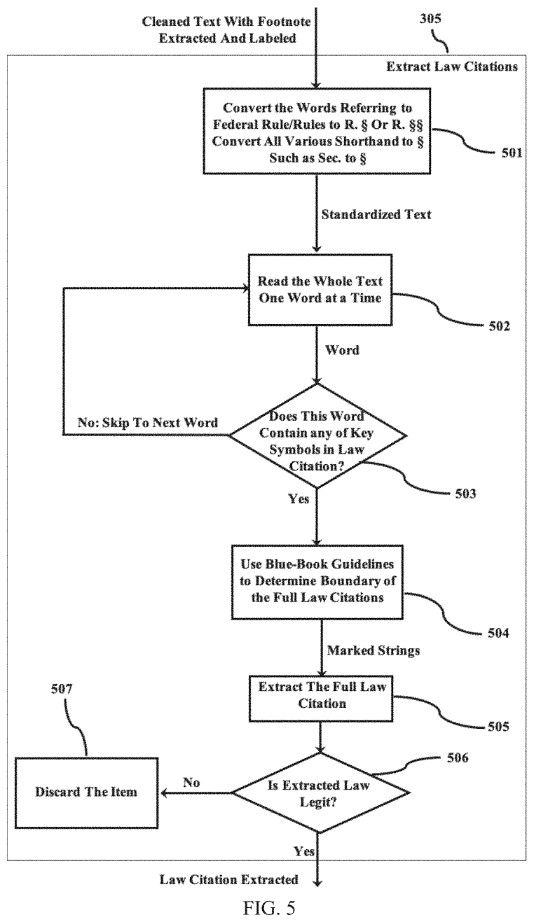

FIG. 5 shows an exemplary, operational flow diagram illustrating how step 305 in FIG. 3 locates legal citations. Step 501 begins this process by standardizing the citations to minimize the amount of coding needed to detect any deviation from the current version of the Bluebook format. The Bluebook is a uniform system of citations used in the United States legal system. Here, standardization is achieved by:

Identifying the most common character(s) used for a particular purpose across all case law;

Combining similar types of legal citations into one standard format by replacing the common character(s) with standard, uniform characters.

This standardization technique helps to succeed in combining the extraction formulas for two similar categories such as statutes and federal rules into a single formula. This approach improves the computational complexity and leads to faster processing. As an example, at step 501, the words “Section(s),” “Subsection(s),” “Sect.” and “Subsect.” are converted to § or §§.

After standardization, step 502 reads the standardized case text to identify any sign of legal precedent. This precedent is located with the use of the standardized identifiers.

Whenever during step 503 a possible legal citation is spotted in the text, the 504 method is triggered. This method locates the boundaries of the legal citation in the text. This part of the logic deploys multi-layer “extraction formulas” to approximate the left and right boundaries of a citation starting from the point at which the location of an abbreviation or a particular symbol was marked by 501 The multi-layer nature of these formulas supports wide range of Bluebook editions dating back to 1990s. This vast range of supported citation formats maximizes extraction capacity and increases accuracy in the calculation of boundaries.

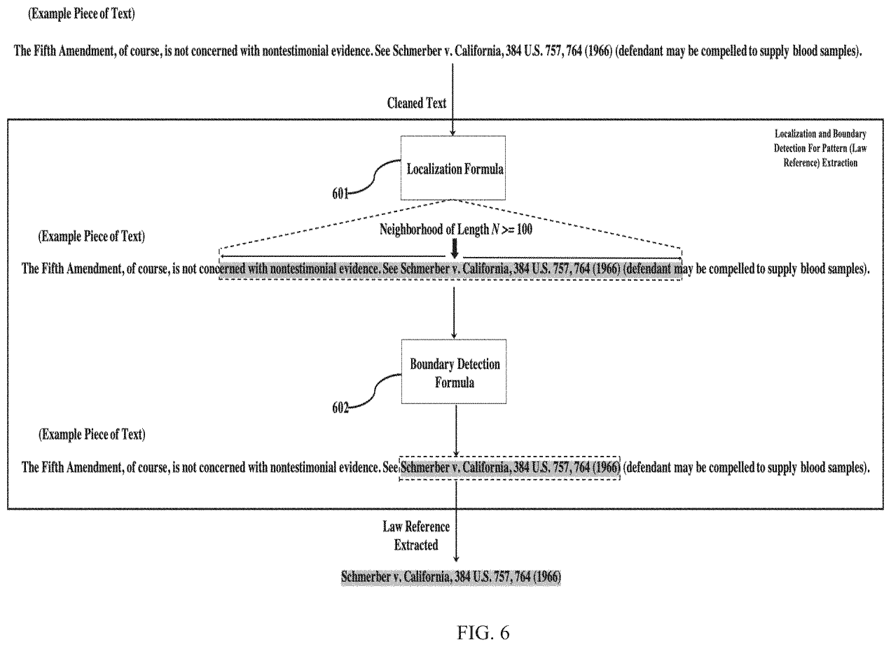

The extraction of citations is important because it expands the system's legal dictionary and produces valuable background context to train the ML algorithm to yield a conclusion about the cited law. The basic rule of thumb is that the more data points for a specific law, the more relevant the returned results will be. Because having more data points yields better results, the extraction formulas must be flexible when encountering different variations of the same reference in order to maximize the extracted data points. The two core concepts used in the extraction phase, localization and boundary detection, are further explained in FIG. 6.

Given a standardized text, the initial stop in the extraction phase is to localize the important characters common to all citations. It should be noted that there are two major challenges to accomplish:

First, the amount of word manipulation in the text needed to minimize due to the legal significance of the words used in the court documents. Here, this minimization is achieved with complex formulas that are able to extract from a version of the case text closest to the original form without the advantages introduced by word manipulations.

Second, the Bluebook goes through major overhauls over time and judges follow different ways of citing the same law. This means that there is no universal formula(s) to detect and extract the full citations without the loss of valuable information. A solution to this problem is described below.

One solution to the first challenge is to use the localization formula sketched in step 601 of FIG. 6 to narrow down the scope of the search in legal dictionary entries or citations. This allows the system to look for an indicator of a citation within a focused window larger than 100 characters centered at a special character common to a category in the citations.

In the second part of the localization process, 602 uses a universal formula to detect boundaries in the focused window. The method used by older systems introduces several different formulas for every category of law to capture the citations falling under each. This older design is inefficient and lacks the ability to adapt to simple variations in a citation. Additionally, in the old system, the cross-formula commonalities could easily lead to redundancies resulting in more intractable overhead for the system. The boundary detection formula in 602:
is highly compartmentalized to cover many forms of the law;
has a large degree of flexibility in detecting any slight changes as the Bluebook is updated;
encapsulates escape routes to avoid catastrophic failures of basic computer logic operations that would often interrupt the automation system; and
is extremely time-efficient and accurate.

Once a law is spotted and its boundaries marked, the result undergoes a sifting procedure for cleaning extra words and characters. Step 507 in FIG. 5 starts the cleaning process by removing characters or discarding the item completely if certain conditions are met.

As an alternative method for extracting law citations, if there exists a list that includes all possible laws, such a list can be used for extraction, in this scenario, the process of citation extraction would be transformed to finding any element of the list in the document.

There are pros and cons to this method of citation extraction. The process of citation extraction is simpler if there exists such a list. However, the list must be kept updated with the latest new case files, codes, and statues. Also, the citation extraction would fail if a law is cited in a document slightly different than how it is recorded in the list. Extracting citations with regular expressions explained above is computationally complex. And it requires hand-crafting these regular expressions that can pick up any law citation. However, such methods to extract law citations can pick up new, unseen citations or any different variations of the law that may not exist in a previously assembled list of laws.

Once all the law citations are mined from the dataset, they are sifted through a logic that removes the repeated citations and assigns a unique ID to each. The outcome, 308, is a dictionary of unique laws where each law has a unique identification number (ID) that replaces its corresponding law citation in the text. The result becomes a document in which all law citations are located and replaced with their IDs.

The final step to wrap up the preprocessing stage is sentence tokenization. A sentence serves as the molecular structure of NLP for useful contextual analysis. Therefore, it is important to determine the boundaries of sentences and break a document into is sentences. To facilitate this, the system runs a piece of code to find the boundary of sentences by taking the output of 306 which is the tokenized case text for all the law citations. The output of 307 are documents in which:
All the paragraphs are marked;
Citations are located and replaced with their IDs; and
Sentences are tokenized.

### Extracting A Training Dataset

The cleaned, tokenized documents produced by step 201 of FIG. 2 contain unstructured data and they are not directly usable as a training dataset for ML applications. Step 202 in FIG. 2 extracts a suitable training dataset from the unstructured text data of these documents. The type and the nature of the training dataset depends on the nature of the data and what the user 101 expects from the research system 104 For example, assume the dataset is comprised of court orders and decisions, the user's query 102 is a summary of facts in hand or a sequence of keywords, and the user expects the relevant laws as the outputs from the research system 104. Therefore, the input-output pairs of the training dataset should be a summary of the issue or keywords and the relevant laws.

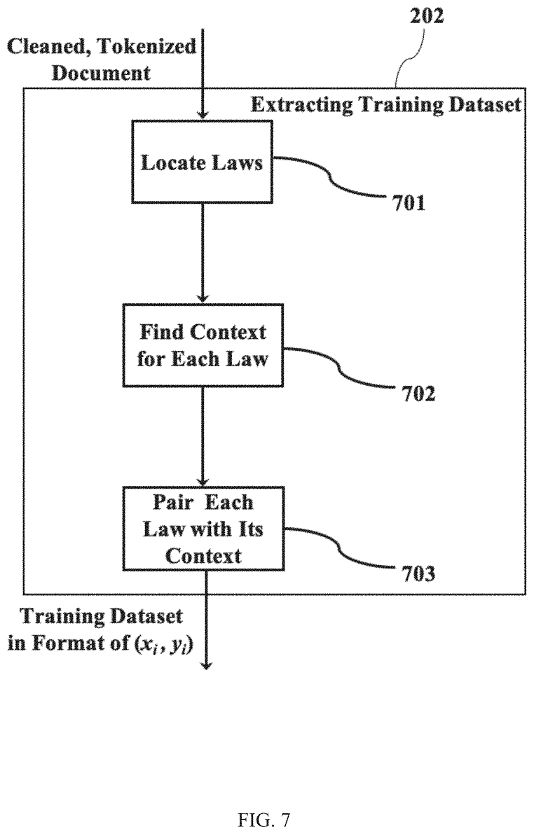

FIG. 7 presents an exemplary, operational flow diagram for extracting a suitable training dataset for developing a legal research system. A similar flow diagram can be used for extracting a training dataset from scientific literature research for a scientific research system. Basically, the main idea behind this operational flow chart is to go over the cleaned, tokenized documents of the case files, locate the laws, and find the context in which the law is applied to.

Specifically, in step 701 in FIG. 7, the laws within the cleaned, tokenized document are located. These laws were already tokenized as unique IDs during step 306 in FIG. 3. The law is the output and the context in which this law is applied is the input. These pairs construct the training dataset. The context is a part of sentence, a full sentence, or a set of partial or full sentences where the judge, Or the author of the opinion, explains or discusses the situation (facts and circumstances) and how and why a law is applied to the situation. Note that while preparing, the training dataset, the law citation from the context is removed. In the present application of ML, the goal is to predict a law based on its context. This means that having the law as the part of the context would render the training process pointless. By removing the law from the context, the ML model is forced to learn how to find relevant, correct laws based on the patterns of facts expressed in the context.

Step 702 in FIG. 7 finds the context for each law. The final output of the FIG. 7 flowchart is context-law pairs, (xᵢ, yᵢ) that construct the training dataset. These pairs make a suitable training dataset to train a ML model to learn what laws are applied to different contexts, and the resulting trained model performs very well as a legal research system.

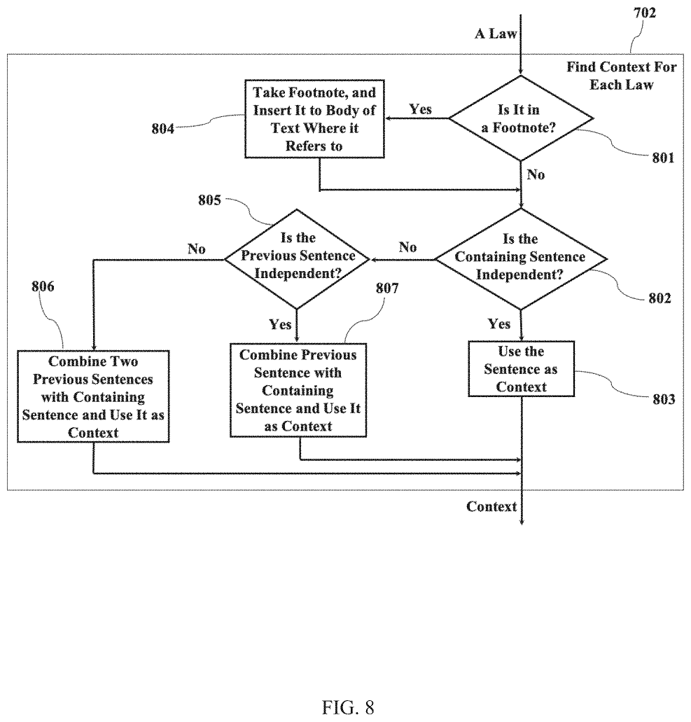

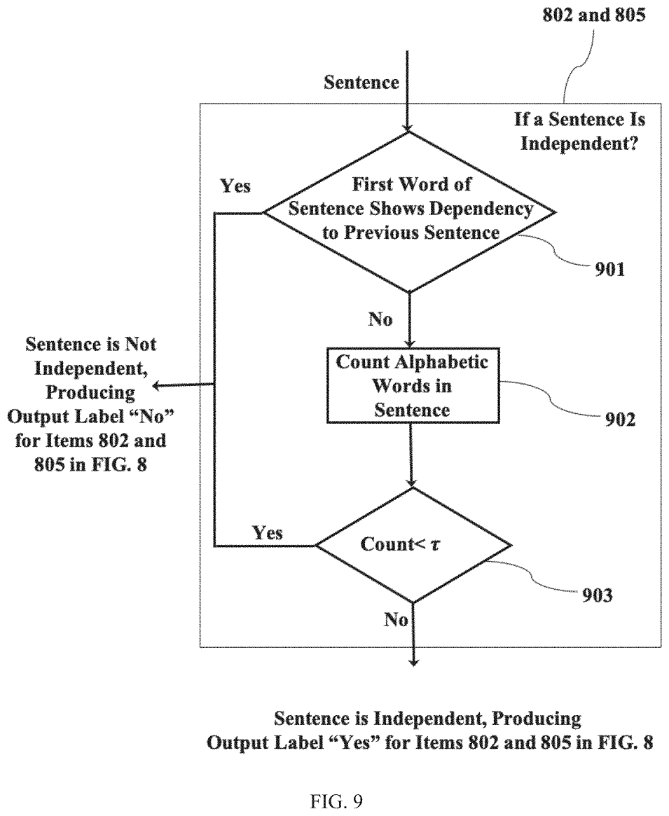

Finding proper contexts for a citation is not a straightforward task to automate and program. Text data of case files is unstructured, and, within a text, there is no explicit marker indicating where the context for each law begins and ends. FIG. 8 presents an exemplary operational flow diagram for finding and extracting context for each cited law. As the first step of this method, step 801 checks whether the cited law is located within a footnote or not. In the case that the citation is within as footnote, there is a possibility that the context or a part of it is in the main body of the case file where the footnote is referring. Stop 804 takes the footnote and inserts it back into the body of the text where the footnote is referring to. Step 802, checks if the sentence that contains the law is contextually independent or not. Note that the sentences are already tokenized during step 307 in the FIG. 3 flowchart, therefore the sentences are already separated by specific marks and locating them in this step is easy. Contextual dependence or independence of the containing sentence is important for knowing whether the entire context for the cited law exist in this sentence, or whether it is necessary to also include other sentences that contain the rest of the context.

FIG. 9 presents an exemplary operational flow diagram for checking dependency or independency of a sentence. At the beginning, step 901 checks whether the sentence starts with one of the words that specifically demonstrates the dependency of the sentence to the previous sentence. Based on studying the corpus a list of such specific words is created. This list includes words such as “thus,” “such”, “therefore,” “but,” “consequently,” “accordingly,” “citing,” “quoting,” etc., that deafly show a notion of dependency to the previous sentence. If a sentence passes this test, then its length is examined as a measure of dependency.

Step 902 counts the number of alphabetic words. Step 903 compares this count against a predefined threshold value, τ. If the count number is below τ, the sentence is deemed too short to be independent. If a sentence does not start with one of the words that shows dependency, and its length is above or equal to τ it is deemed independent. τ value is a hyperparameter and needs to be adjusted through random search or other exploratory techniques to find an optimal threshold value. In one embodiment 6 was used as a threshold value. But depending on the corpus and the writer's style, the optimal value can be different in other embodiments.

Back to FIG. 8, if the sentence that contains the citations is deemed independent during step 802 in FIG. 8, then the sentence is considered as the sole context of the observed citation as determined by step 803 in FIG. 8. If the containing sentence is determined to be dependent on its previous sentence, then it is checked Whether the previous sentence is independent or not, which is done at step 805 in FIG. 8. If this previous sentence is independent, then the combination of the previous sentence and the containing sentence is considered as the context, 807 in FIG. 8. If the previous sentence is dependent to its previous sentence, then the combination of two previous sentences and containing sentence is used as the context, which performed by step 806 in FIG. 8. Note that the sequential dependency of sentences is considered until two previous sentences. The examinations and tests performed on the corpus suggest that checking dependency up to the two previous sentences results in acceptable accuracy in determining and preparing the complete context of a cited law, but of course going back and checking for more than two sentences can result in better accuracy.

The FIG. 8 exemplary operational flow diagram for finding the context for each law citation can be further enhanced by considering how many different law citations coexist in the same sentence. It is possible that a sentence can contain multiple citations with different contexts. As an example, imagine a judge starts a sentence by explaining an issue and his/her ruling on that issue according to a cited law, and then switches to a separate issue and its separate ruling and different law citation. This can all occur in the same sentence. In such sentences, it is necessary to separate the sentence into two parts, separating the two contexts from the other and assigning each to its corresponding cited law. A set of rules is designed to handle sentences with multiple citations.

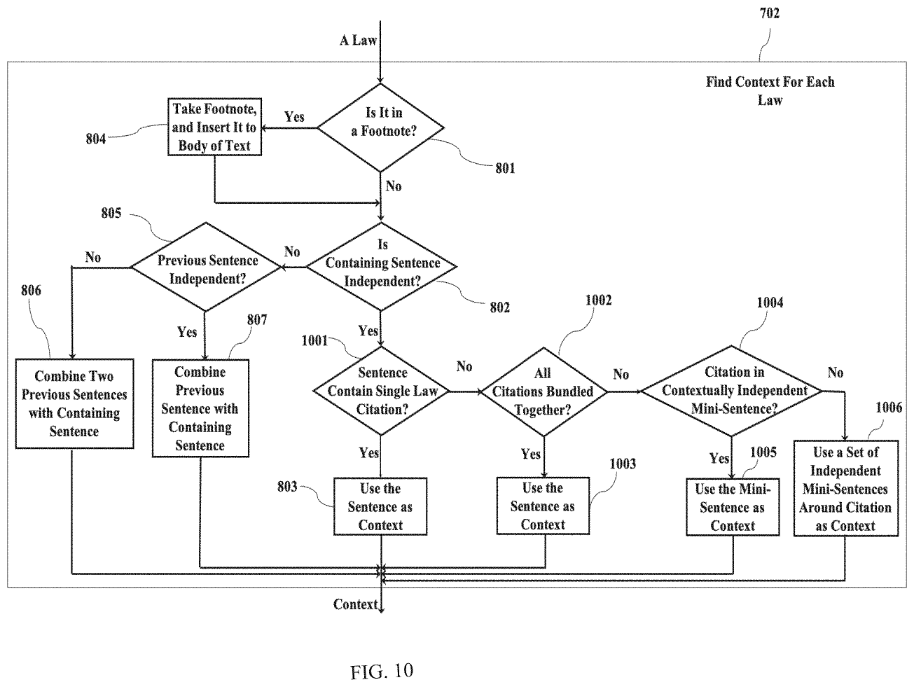

As an example, FIG. 10 is a version of the FIG. 8 flow chart that also considers the number of citations in the same sentence and extracts the context for each citation according to the locations of the laws in the sentence and the context of the sentence. Step 1001 checks the number of citations in a sentence. If the number is one, the context would be extracted similar to with the FIG. 8 flowchart. But if the number of the law citations is higher than one, the new part of the logic would be triggered, and a new set of rules will be applied to find the context.

Step 1002 checks if all citations are bundled in the same location of the sentence or not. If so, it means all citations share the same context, therefore the entire sentence is the context. FIG. 10 can be further enhanced by checking whether this sentence is independent or not. And if is not, the previous sentence or sentences can be combined with the containing sentence in order to come up with a contextually independent context for the citation. This improvement is not shown in the FIG. 10 flow chart. If the laws are cited in different parts of the sentence, it means that the context might be different for each law.

Step 1003 checks whether each citation is located within a mini-sentence that is independent from the rest of the mini-sentences, and if so that mini-sentence is used as the context for the law.

Step 1004 breaks the sentence into mini-sentences by using semicolons and commas as breaking points. And the criteria for dependence or independence of a mini-sentence is the same as for a sentence. The FIG. 9 flowchart can be used to determine dependence of a mini-sentence as well.

If the citation is not within an independent mini-sentence, step 1006 finds a collection of mini-sentences that are contextually independent and uses them as the context for the citation. The FIG. 10 flow chart can be further improved by additional rules. These rules to some extend depend on the nature of the corpus and the composition style of the documents. The rule of thumb is the more precise the rules, the better contexts for the citations. Better contexts can result in a better training dataset.

It is important to note that finding the exact contexts for citations is not a must for the operation of the research system 104. During training, the ML model looks for and learns the common, coherent patterns among different contexts for the same law, and it ignores the incoherent details (noise). Therefore, the research model and its training process is to some extent robust against extra irrelevant texts (noise) that find its way into the contexts.

### Machine Learning

Different types of ML models can be trained over this training dataset to learn a function that can map the contexts to the laws. Depending on the selected ML model, the training dataset needs to be transformed to a friendly format for that model. Step 203 in the FIG. 2 flow chart performs this task. For example, in one embodiment, a Naïve Bayes model is trained over the training dataset. The context for each citation is transformed into a feature vector acceptable by the Naïve Bayes model. There are different transformation methods to extract a feature vector from a text. Hashing vectorization, TFIDF vectorization, etc., are a few examples methods that can be used to transform a text into a feature vector that is useable by ML algorithms such as Naïve Bayes classifier.

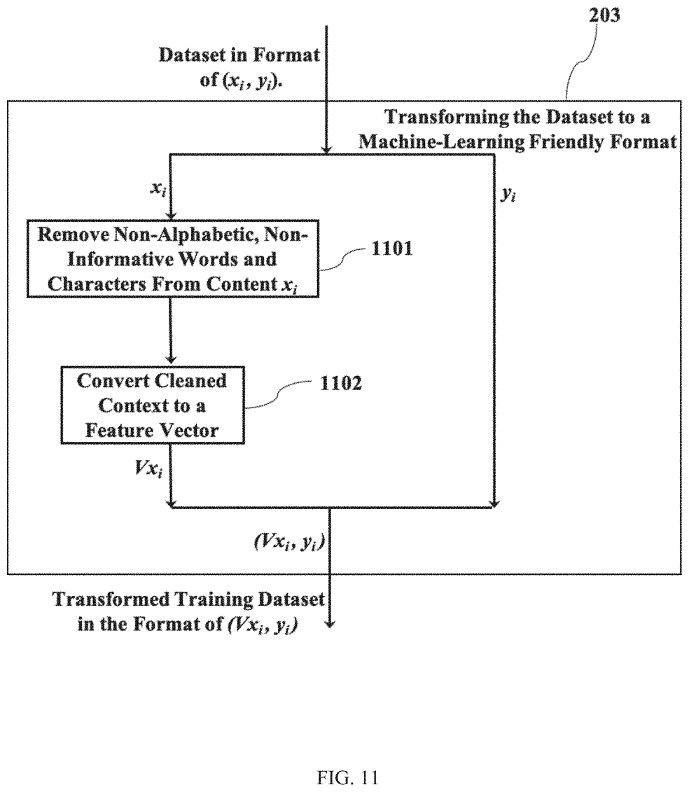

FIG. 11 presents an exemplary operational flow diagram for converting the training dataset to a format usable by Naïve Bayes method. Step 1101 cleans the context text from nonalphabetic, noninformative words.

Step 1102 transforms the cleaned context, xᵢ, into a feature vector Vxᵢ using TFIDF. The output of the FIG. 11 flow chart is pairs of transformed context-laws in the format of (Vxᵢ, yᵢ). This transformed training database is suitable to be used by many ML models including Naïve Bayes model. Other ML models, such as Support Vector Machines, Random Forest, or multilayer neural networks, could be trained over this training dataset gas well. These models are classifiers that learn how to classify different contexts into their relevant labels, which are laws in this example. Step 204 in FIG. 2 receives the transformed dataset and trains a ML model. The details for train in a ML model depend on which ML model is selected. For example, training a Naïve Bayes model is comprised of estimating the likelihood of different classes, here laws, for different feature values, and estimating prior probabilities of different feature values. Then the Naïve Bayes formula is used to calculate which law is more probable given a feature vector. The trained model is now ready to be used by the user 101 as part of the research system 104.

FIG. 12 shows an exemplary schematic for how a user can use this trained model as a research system 104. Note that the user's query 102 is a regular text, which is not understandable by the trained model. Step 1201 transforms this query into a model-friendly format. This transformation is usually the exact same transformation that was used to transform the training dataset into a ML-friendly format.

In step 1202, the trained model receives the transformed query, and produces an output as an estimation for relevant laws.

Step 1203 receives the model outputs, which are in the form of law IDs, and transforms them back to original Bluebook citation format.

Naïve Bayes classifier, Support Vector Machines, Random Forest models, and other similar classical ML models perform fairly well on small datasets with few classes. But these basic ML models usually do not scale well with the size of the dataset or the number of classes in the dataset. In legal research, scientific literature research, or patent search, the number of training data points is in the millions, if not billions, and the number of classes (which is the number of laws in legal research use examples) can be in range of hundreds of thousands, if not millions. Classical ML models may not efficiently handle such large problems.

Modern DL models and techniques have proven themselves extremely efficient and capable in handling large datasets and problems. Modern DL methods scale very well with the size of training dataset and the number of classes. The research system 104 includes the designed and application of DL models and techniques that are trained on such large databases and be used as a research system.

There are two main differences between the classic ML and DL approaches to process text data: 1) how to model and represent the text data, and 2) the models themselves.

As mentioned before, the training dataset needs to be transformed into a format that is suitable for the ML model. This transformation may change depending on the choice of ML model.

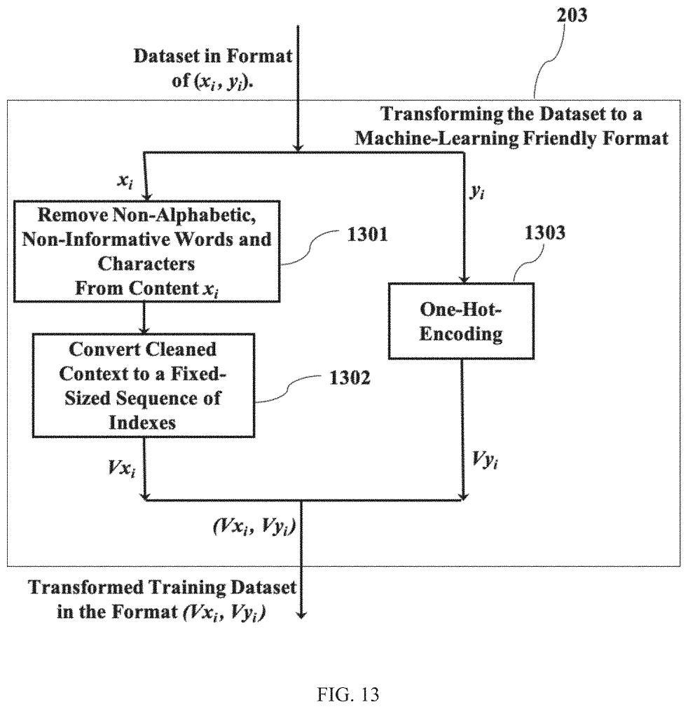

FIG. 13 explains yet another exemplary transformation that works well for deep neural networks. Process 1301 removes non-informative characters or words from the context. In some embodiments, stop words such as “the”, “a” and “in” are removed from the context as well because the frequent use of stop words turns language into noninformative or indiscriminative data. Each word in the vocabulary is indexed with a unique integer number.

Process 1302 transforms the cleaned context into a fixed-sized sequence of these integers based on the words in the context. The first integer in the sequence is the index of the first word in the context, and so on. If the size of the context is smaller than the predefined size of these sequences, the resulting sequence is padded to ensure that all sequences are of the same size. If the size of the context is larger, a portion of the sequence is cut away. Step 1302 outputs Ln for each context xᵢ.

FIG. 13 also transforms any legal citation, yᵢ, using one-hot-encoding and produces Vyᵢ. These transformations that come in different varieties, are common in text preparation for DL models.

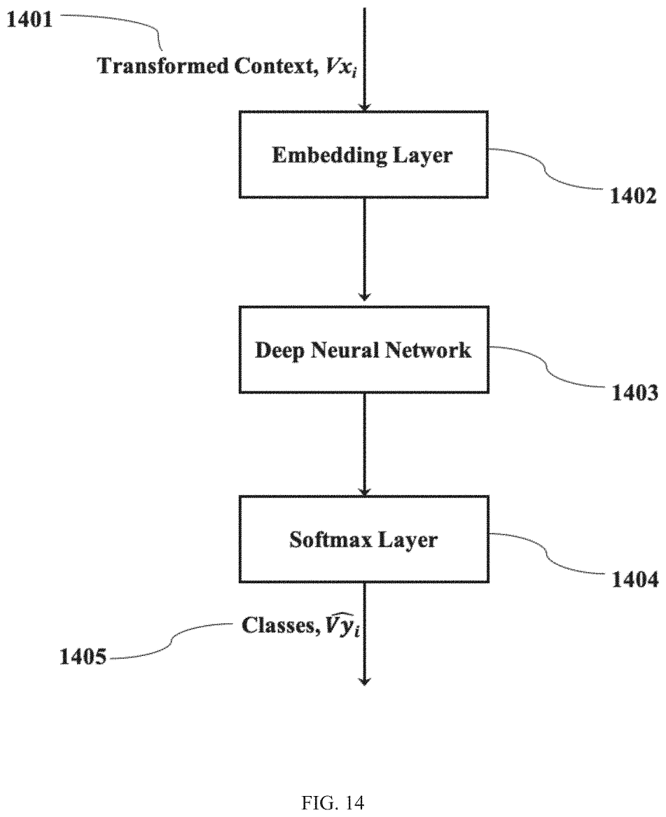

FIG. 14 shows an exemplary architecture for a DL model to be used as part of the research system 104. This model receives the input data being the transformed context Vxᵢ, and estimates a law (legal citation) [symbol] ᵢ, which is what the model thinks is relevant to the input context. Notice that the hat \hat{ } in [symbol] ᵢ emphasizes the fact that [symbol] ᵢ is the model's output law and in practice it could be different from the mound truth Vyᵢ. A ML or DL model is a parametric model whose ability to map its input to the output can improve by adjusting its parameters. Through this training process, the model will learn to output [symbol] ᵢ that is the same or at least very close to the ground truth Vyᵢ.

In some instances, the first layer of the DL model may be an embedding layer, shown as 1402. The embedding layer receives the context words and assigns a word vector for each word. A word vector is a model for a word in which each word is transformed into a vector in an M dimensional space. This transformation is designed in such a way that it preserves the semantics and syntactics between the words and transforms them into geometrical relationships between their corresponding word vectors. This means that, for example, the word vectors of synonymous words would sit close to each other. That is to say that the distance between the word vectors of a pair of words can be considered as a similarity measure between the words. A common distance measure in ML is the “cosine similarity” GloVe (J. Pennington et al., “Glove: Global Vectors for Word Representation,” Proceedings of the 2014 Conference on Empirical Methods in Natural Language processing (EMNLP) (2014)), and Word2vec (T. Mikolov et al., “Distributed Representations of Words and Phases and Their Compositionality,” Advances in Neural Information Processing Systems (2013)) are two example methods to calculate word vectors for each word from a corpus. One can use a pre-trained version of such word representations, which are already trained on generic corpuses such as Wikipedia entries. However, such pretrained models may or may not contain the jargon or technical words within the records of the database 105 that the research engine is intending to explore. It is preferable to train such word representation models on the actual database, if the database 105 is large enough to allow these models to be trained properly.

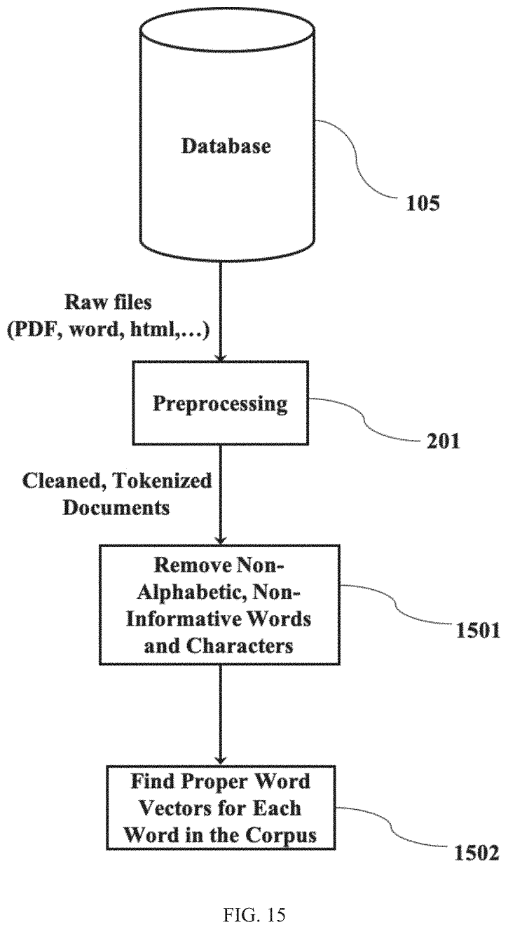

FIG. 15 shows an exemplary flow chart for training these models and obtaining word vectors. A corpus is composed of the text of all the documents in the database 105 that have gone through preprocessing and cleaning process in steps 201 and 1501.

Step 1502 calculates word vectors for each word in the corpus following Word2vec, GloVe, decomposed co-occurrence matrix, or other similar methods. The data available in the database 105—for example, all the case files from the U.S. 4th Circuit Court of Appeals—were sufficient to properly custom train a Word2vec model. The tests showed that this custom-trained model performs better than pretrained Word2vec models trained on a generic corpus.

When using such embedding methods to embed and transform a word in an M dimensional space, embedding layer 1402 can be considered as an N×M matrix containing word vectors for all the words in the vocabulary, where N is the size of the vocabulary, and each word vector is of size M. The index of a word vector in the matrix can be the same index that 1302 uses for the same word. For example, if an index reads 576 in step 1302, the word vector for its word is stored at location 576 in the embedding layer. In short, the outputs of 1302 in FIG. 13 can be indices referring to the word vectors of every word in the context.

Some words in a language have multiple meanings. For example, the word “left” can be the past and past participle of the verb “leave,” it can be an adjective for a person or group of people favoring liberal, socialist views; or it may refer to the left side of an object. The context in which the word “left” is used determines its exact meaning. Therefore, having a fixed word vector for a word regardless of the word's specific meaning results in both loss of information and having difficulty in finding results relevant to the query. Ideally, one wants to have different word vectors for polysemic words to mean different things. Contextualized word representation methods in which the vector for a word depends on the context wherein the word appears may be used. A non-limiting example of such a model is ELMo (“Embeddings from Language Models”) (M. Peters et al., “Deep Contextualized Word Representations,” arXiv preprint arXiv:1802.05365 (2018)). ELMo, and other similar word representation models perform two tasks: 1) they model characteristics of word use such as syntax and semantics, and 2) they model how these uses vary across linguistic contexts.

Similar to GloVe and Word2vec models, a pretrained version of ELMo can be used. Or ELMo can be custom-trained on the database 105. Either way, the end result is a model that receives a sentence or any other sequence of words, and outputs a word vector for each word. In the present research system 104, a pretrained ELMo model may be used. The difference between ELMo (or similar contextualized word models) and GloVe or Word2vec is that in ElMo, the word vector for each word depends on and produced by the entirety of the input sentence, not just the word itself. This ensures that a polysemic word gets an accurate word vector. When using ELMo or other similar embedding models, the 1402 embedding layer is going to be the ELMo model that receives the sequence, and outputs a word vector for each, depending on the context.

The 1402 embedding layer converts the context for each law to a set of word vectors, one vector for each word.

Deep neural network 1403 in FIG. 14, which can have a wide range of architectures, combines and processes word vectors and maps them to a proper law. Note that the entirety of FIG. 14 architecture, which includes the embedding layer 1402 and output layer 1404 is itself called a deep neural network, or a DL model. We call a component of it, the layer 1403, a deep neural network to highlight the fact that it itself is a deep network, which can have different architectures. The task of neural network 1403 is to learn and spot the important patterns of facts within the input that are related to different laws in the research system 104, the following deep neural networks could be used for layer 1403.
deep feedforward neural networks;
recurrent neural networks of different types (simple RNN, LSIM, GRU);
stacks of recurrent neural layers;
bidirectional recurrent neural networks of different types (simple RNN, LSTM, GRU);
convolutional neural networks for text processing;
attention neural networks;
transformer networks,
and many other types of neural networks.

Also, “hybrid” neural networks—a composition of some of the networks mentioned above—could be used. Without limiting the scope of this application, a few examples of such designed hybrid architectures are listed below:
recurrent neural networks or bidirectional recurrent neural networks (including stacks of recurrent neural layers or bidirectional recurrent layers) connected to feedforward neural networks;
multi-branch convolutional neural networks;
convolutional neural networks or multi-branch convolutional neural networks connected to feedforward neural networks;
convolutional neural networks or multi-branch convolutional neural networks connected first to an attention layer and then attached to feedforward neural networks;
recurrent neural networks or bidirectional recurrent neural networks connected first to an attention layer, and then attached to feedforward networks.

Back to FIG. 14, in the DL model, some embodiments may contain an output layer, producing the outputs of the model. Deep neural network 1403 spots and extracts different factual patterns in the input, and the output layer based on the presence or absence of different patterns in the inputs produces a law relevant to the input.

Layer 1404 may be a softmax layer, which is commonly used as the final layer of neural networks for classification tasks. Any alternative layer than could assign a probability, a likelihood or a rank to different potential classes could be used as the output layer of the model. The softmax layer basically generates a probability distribution for every potential outcome. In the legal case example, the softmax layer gives a probability for each possible law in a way that a higher probability is assigned to a more relevant law with respect to the factual patterns in the input, and a lower probability goes to a law that the model thinks is less relevant.

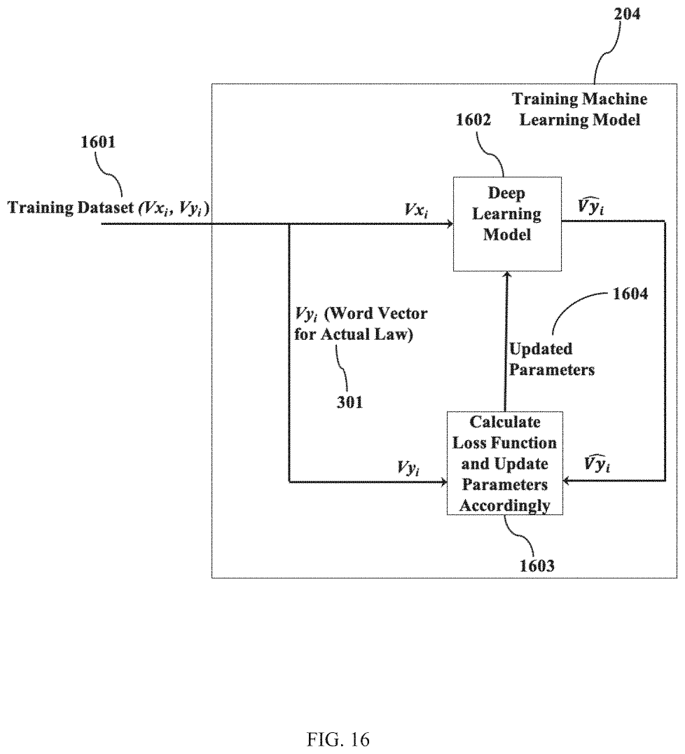

FIG. 16 is an exemplary diagram showing how a DL model, serving as the legal research engine, can be trained on the training dataset to map an input context to relevant laws. FIG. 16 is indeed an exemplary embodiment for training step 204 in FIG. 2. The transformed training dataset 1601 is produced as per FIG. 13. The DL model 1602 is of the type depicted in

FIG. 14. This model receives the transformed context and produces a law denoted by [symbol] ᵢ. This is the initial output of the model that may be different from the ground truth, which is the actual law according to the training dataset. The goal of training is to adjust the parameters of the model in such a way that its output laws become identical to the actual laws.

Process 1603 compares the law produced by the model against the actual law. This comparison generates a “loss” value and the smaller the value, slighter is the difference between the output laws and the actual laws. Therefore, by adjusting the parameters of model 1502, one can reduce the loss value.

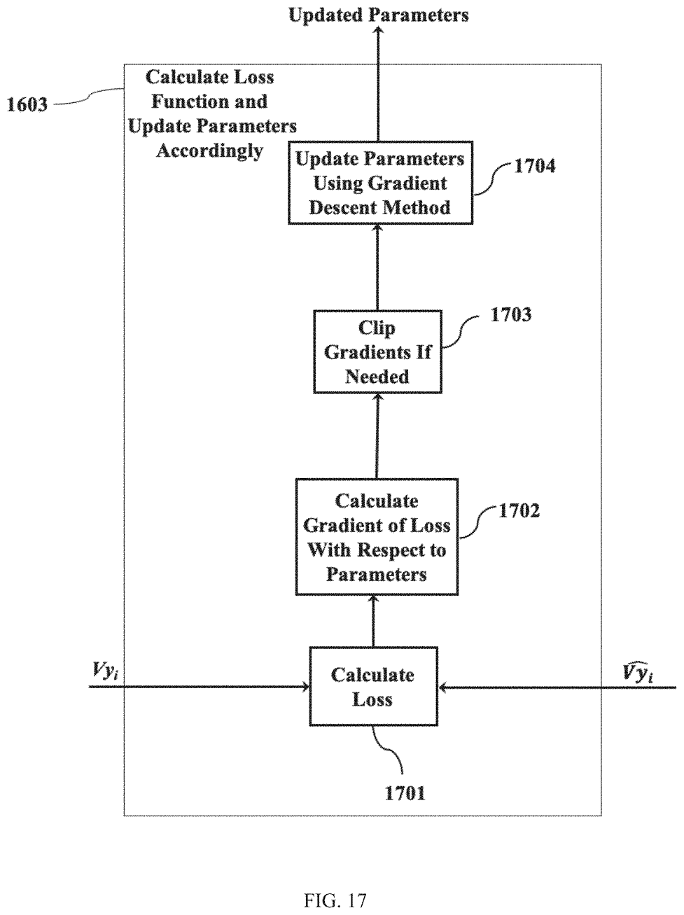

FIG. 17 shows an exemplary diagram for step 1603. Step 1701 receives both the output law and the actual law and returns a loss value generated by some loss function. Training a ML model is indeed an optimization process that aims to minimize the loss value by adjusting the parameters of the model. The gradient descent method is one of the commonly used techniques for this adjustment. To this end, step 1702 calculates the gradients. In some embodiments, step 1703 may trim the gradients to prevent the known gradient exploding problem. The output of FIG. 17 is the updated parameters of the DL model. In the training process, batches of training pairs are provided to the model and the loss value of the entire hatch is calculated. Then, using the collective loss value of the batch, the gradients and parameters are calculated and adjusted.

Generally speaking, classification and regression are two important types of ML algorithms that differ in terms of the nature of the outputs they produce. The output of a classification problem is a label, a class, or any discrete entity. On the other hand, in regression problems, the task is to predict a continuous variable. So far, the training of a ML model is treated as a classification problem that deals with laws as discrete labels. Treating laws (or patents, literature articles, etc.) as continuous-valued vectors can greatly enhance the predictive power and scalability of the research system 104. Thus, a continuous-valued representation for each law is used and, accordingly, in another model for use in the research system the training process is redesigned to predict these representations.

The number of laws cited in the database 105 of the federal/state court opinions may easily reach millions. Of these laws there are many that have just a handful of contexts for why they are cited. In a classification problem, the models are expected to predict the correct law out of this large pool of cited laws for a given input query. An ordinary skilled person understands that on the one hand, there are several technical challenges associated with the fact that the system has to now classify a query into millions of different laws. On the other hand, representing the legal citations with unique discrete labels means that the contextual correlations among the laws are not essentially accounted for. Accordingly, the system does really have no sense of legal distance in terms of where two laws stand from the perspective of the court system.

Here, the laws are transformed into dense, continuous-valued vectors in a dimensional space called state space based on the contextual similarity of the laws. A context for each law is determined by looking at the contexts of the citation in the court case text. Since the transformation does preserve the contextual similarity of the legal citations by placing correlated laws close to one another in the state space, contextually similar laws end up being mapped to close-by vectors in the state space, In some embodiments, the laws may be mapped to the same state space that the words are mapped to.

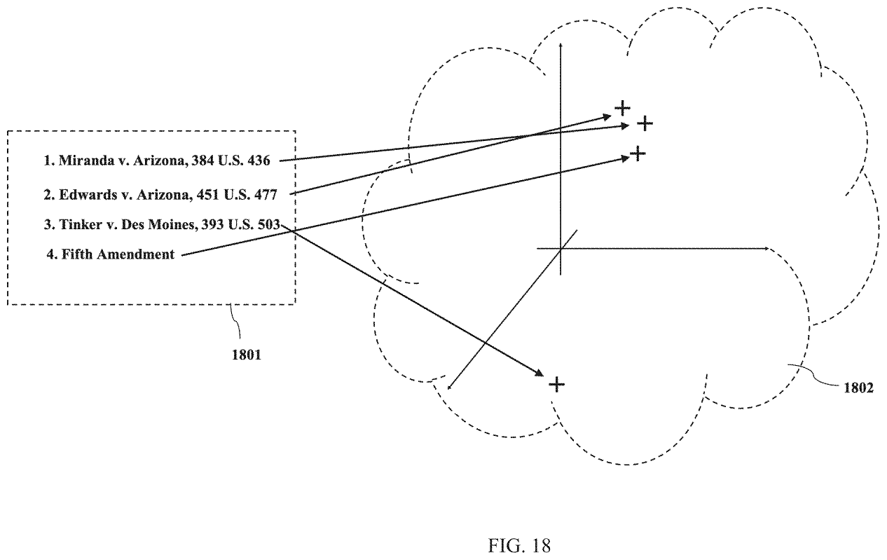

FIG. 18 is an exemplary visualization of this process. Box 1801 lists four sample laws represented by 4 cross symbols in the state space. In reality, the dimension of this space is on the order of hundreds, but for better visualization the dimension is set to three. The citations given in 1 and 2, namely Miranda v. Arizona, Edwards v. Arizona, mainly deal with the fact that no confession could be admissible under the Fifth Amendment self-incrimination clause, whereas the case in 3, Tinker v. Des Moines, discusses the freedom of speech in schools that falls under First Amendment jurisprudence. If one were to provide these laws to a machine as discrete labels and expect it to learn and return the related ones given the data receded from a user's input query, the contextual relationship between these laws would simply be ignored. Instead, the laws are transformed to vectors in continuous state space 1302 where the distance between any two vectors is a measure of the similarity of the corresponding laws.

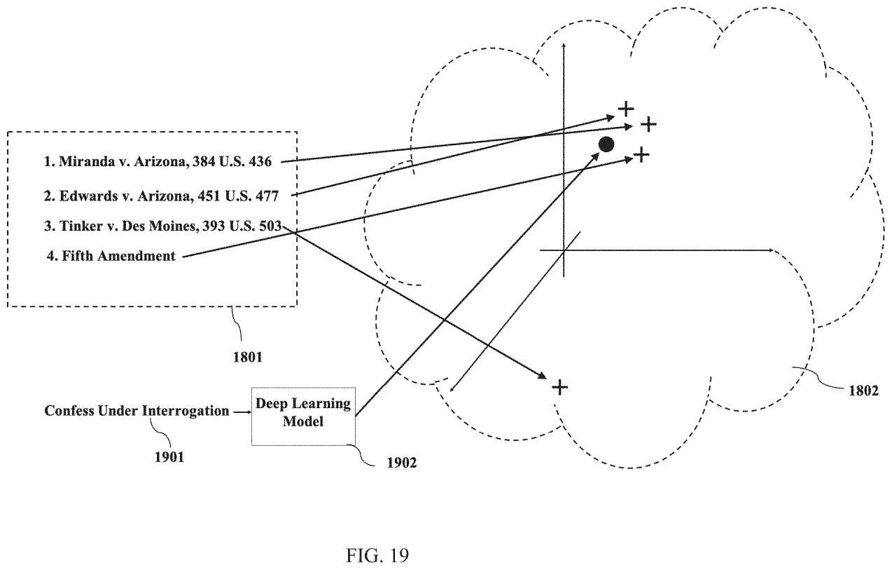

An example context and a trained DL model operating as a research system is now presented to clarify the concepts. In FIG. 19, input 1901 (“confess under interrogation”) is the context of aa query provided by the user 101. DL model 1902 treats the legal research as a continuous (regression) problem. It essentially receives the user 101 input and outputs a vector in state space 1802, depicted with the circle. The relevant laws are those with vectors closest to the model's output vector, namely Miranda v. Arizona, Edwards v. Arizona, and Fifth Amendment. Here, the irrelevant law is Tinker v. Des Moines whose vector sits far from the output vector, which will then be discarded by the model when showing its results. With this technique, the DL model just needs to learn to which part of state space it has to map the input query as opposed to having to learn an incredibly huge number of laws and map the input to each one of these laws separately. As a result, a regression ML model dealing with legal research (or patent search, literature research, etc.) as in this application can scale much better with respect to the number of laws (patents, research articles, etc.) and is much faster and easier to train.

To switch from a classification ML model to a regression one that solves the legal research problem, the following modifications are made: (1) the laws need to be represented as continuous dense vectors; (2) the design of the DL model of FIG. 14 is changed so that it outputs a continuous vector; and (3) the loss function in FIG. 16 is readjusted so that it can measure the difference between continuous-valued output and actual laws.

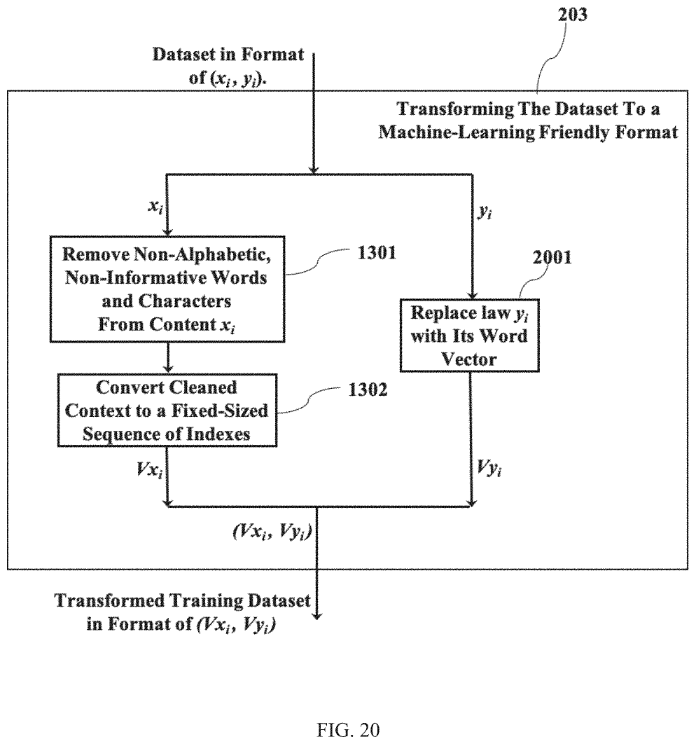

FIG. 20 shows an exemplary flow chart for transforming the training dataset into a ML friendly format in which the legal citations are transformed into continuous-valued vectors. The flow charts in FIG. 20 and FIG. 13 are for the most part identical except that step 2001 has replaced step 1303 of FIG. 13. The transform in step 1303 uses the one-hot-encoding method that gives a discrete-valued vector for each law without considering the similarity between the laws. Step 2001 replaces each law with its word vector. FIG. 15 flow chart produces a word vector of size for each word, including the tokenized laws in the corpus. As a result, in some embodiments step 2001 may replace each law with its word vector of size M by FIG. 15 flow chart. In some embodiments, laws and regular words may be mapped to two separate state spaces, and these state spaces may have different dimensionality. Either way, at the end, each law is represented by a vector in a state space, and due to the fact that the word vector transformation relies on the context of each law citation, similar laws end up close to each other.

It may be assumed that, for purpose of a research system 104, 1) the laws are mapped to the same M dimensional state space that words are mapped as well, 2) word representation method Word2vec may be used to assign a vector to each law. Note that even when ELMo or other context-aware models are used as the embedding layer 1402 to assign word vectors to input words, the Word2vec method may still be used for representation of laws as a vector and the model will output an estimated law in this output space.

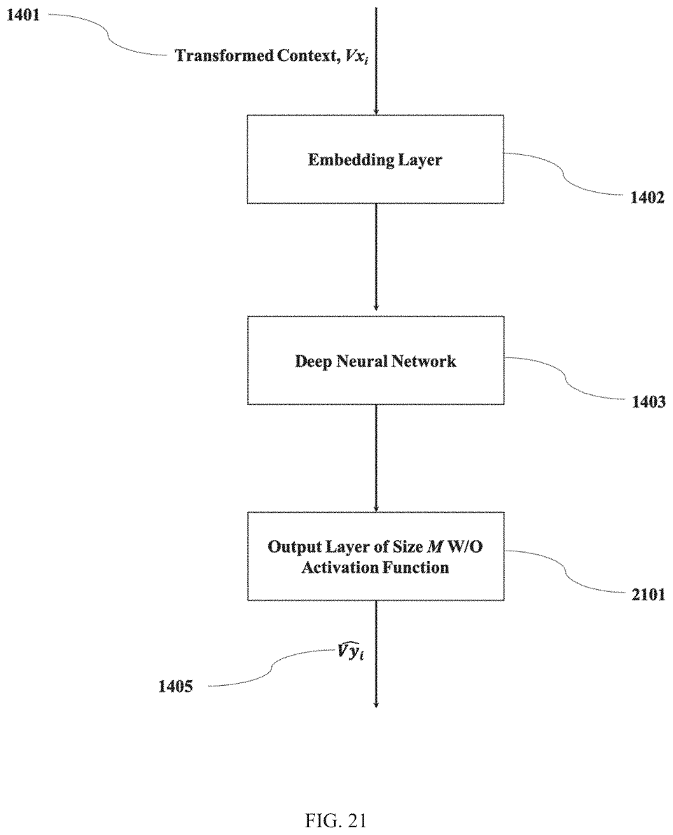

FIG. 21 shows an exemplary diagram for a DL model treating the laws as continuous-valued vectors. This is a replacement for the classification model in FIG. 14. The diagrams in FIG. 21 and FIG. 14 are different in that the output layer 1404 of FIG. 14, which may be a softmax layer, is replaced by the output layer 2101. The softmax layer assigns a probability to every possible law relevant to the input context. In contrast, the output layer 2101 produces a continuous-valued vector of size M. This means that, given an input context to the model, the model produces an output vector in the M-dimensional state space as an estimated location for the relevant law. The word vectors of all laws exist in this this M-dimensional state space as well. The laws that their word vector fall within a small neighborhood of the location of the output vector in the state space will be returned to the user 101 as the relevant laws. This subject will be discussed in more details later in this application.

For the regression DL, a similar training process is used in FIG. 16. Also, a similar process is used for calculating the loss value and updating, the parameters in FIG. 17 with a slight change in the form of the loss functions. Instead of loss functions such as categorical cross entropy that are suitable for classification problems, loss functions such as mean squared error or cosine proximity that are appropriate for regression problems need to be used.

Thus far, the focus has been on training a model that takes a context from the training dataset and successfully predicts the correct law that applies to the situation explained in the context. Although this approach sounds good as it stands, ideally one wants this model to generalize beyond the training dataset. This means for the model to be able to respond for a given context with the relevant laws that were not in the training dataset. This concept in ML is called “generalization”. When a model performs well on the training dataset but fails to generalize beyond the training dataset, it is said that the model is overfitting to the training dataset. Consider again the example of intelligent legal research system that uses ML. The user 101 submits a summary of an issue to this system. A research system that is severely overfitting to the training dataset would only return the relevant laws if the user uses a very close language and structure to one of the exiting contexts in the training dataset, otherwise the research system 104 would fail to return laws relevant to this unseen context. It needs to mention that generalization does not mean that a model should magically learn to locate the relevant laws or handle situations that it has never been exposed to. It rather means to the model to not memorize the entire context but to learn the important contextual patterns of facts in every case text and recognize the relevant laws that apply from these patterns. Then, once a new text is submitted, the model should be able to compare it against the learned patterns and return the laws accompanied by any similar pattern to the user 101.

The research system 104 is developed following techniques to prevent over fitting and to ensure that the ML models will be able to generalize beyond the training dataset. More specifically, regulators are used to constrain the massive learning capacity of the DL models. If left unchecked, the models would probably end up memorizing the entire dataset. Memorizing the entire dataset means that the models have a way of mapping every context to some legal citation without actually learning the patterns in the context to make further educated predictions on unseen data. By actively constraining the learning capacity of a DL model, mindless memorization is avoided and the model is forced to learn the important patterns in the dataset.

To this end, in deep neural network 1403, the following regulators may be used: dropout, L1 and L2. In particular, the training dataset is augmented at each epoch during training, which is yet another attempt at preventing memorization. The ML model undergoes many different epochs of training. The entire training dataset is given to the model in batches at each epoch for training purposes. Memorization is minimized by providing a slightly augmented version of the data, rather than dumping the same training dataset into the model during different epochs. In this invention, multiple different techniques are introduced to alter (augment) the contexts without compromising the integrity and meaningfulness of the text data of the court cases. Particularly:

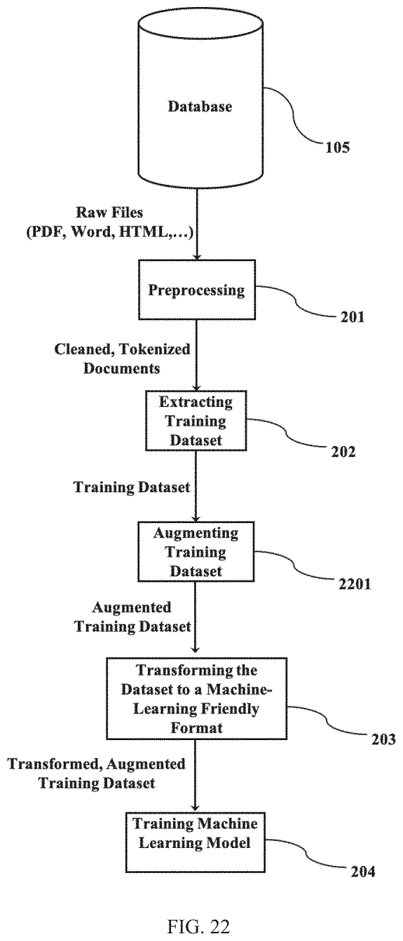

In some embodiment, an English dictionary (or any other dictionary depending on the language of the context) that has all the synonyms for every word is used. A few words (or just one word) are randomly taken from each context and they are replaced with their synonyms. The exemplary flow chart in FIG. 22—being an alternative version of FIG. 2 flow chart—shows the stage of training at which the training dataset is augmented. Step 2201 is the new step in the pipeline that generates an augmented version of the training dataset.

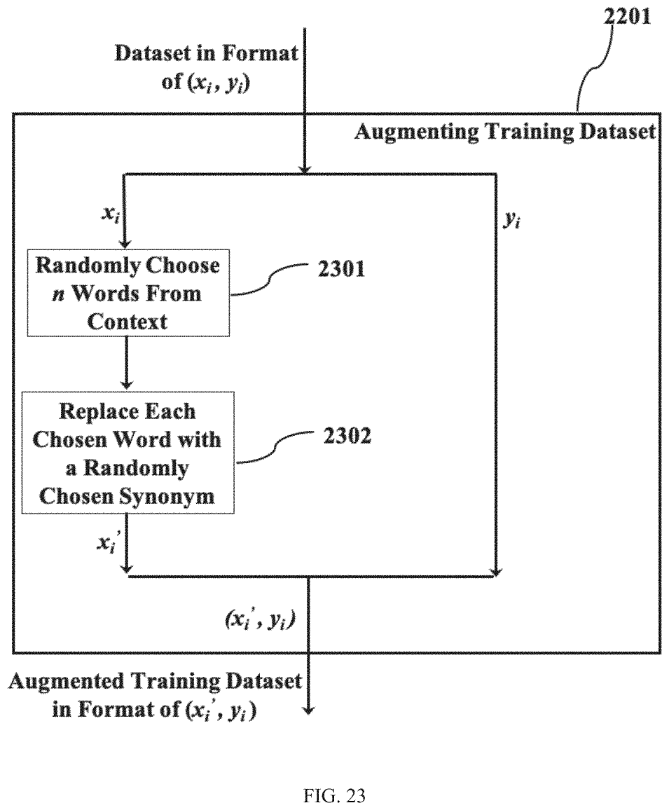

FIG. 23 is an exemplary flow chart for step 2201, showing how the training dataset may be augmented. Step 2301 randomly chooses n words from every context. n is a hyperparameter, which generally is tuned to an arbitrary percentage of the length of the context. In some embodiment, n is set to 10%.

Step 2302 replaces every chosen word with a randomly selected synonym from an English dictionary.

In some instances, a word is randomly removed from the context, or some words are randomly swapped. The flowchart for this process is similar to FIG. 22 and FIG. 23, but instead of replacing randomly chosen words with their synonyms here and there, these words are removed from the context or swapped. This again provides some type of augmented training dataset, which prevents the model from memorizing things.

In the models shown in FIG. 14 and FIG. 21, the embedding layer 1402, transforms every word in the context into a continuous-valued vector that serves as a representation of that word in an M-dimensional state space. An important aspect of this space is that the similar words wind up being close to one another. To put augmentation into use again, a small “noise” vector may be added to the vectors without changing the meaning of their corresponding word. The resulting vector will still reside in the vicinity of the original word vector, which indicates that the meaning of the word is not completely altered. The aim is again to prevent the model from memorizing the exact training dataset so that it starts to pick up the contextual patterns and facts that eventually determine the laws relevant to a context.

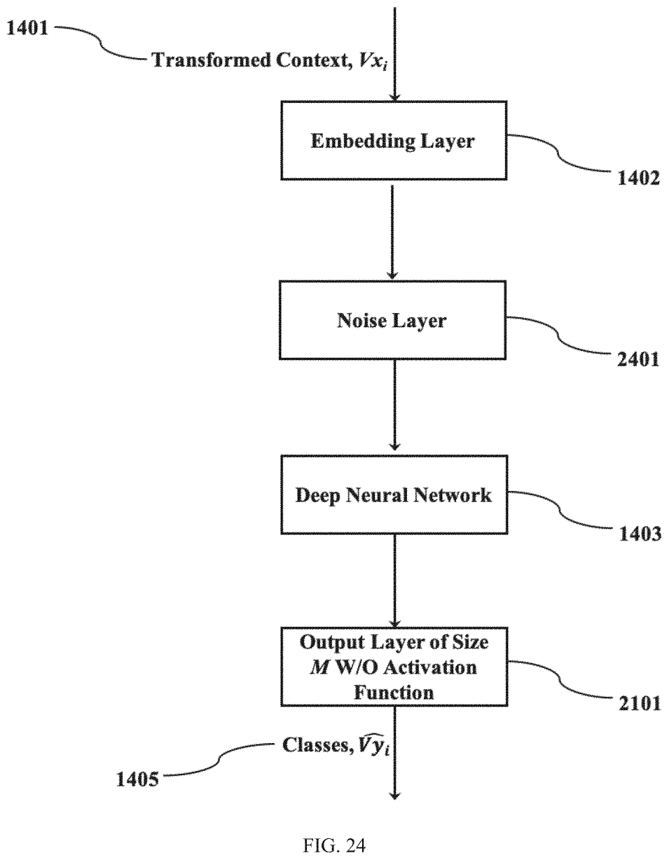

FIG. 24 shows an alternative DL model. In this model, noise layer 2401 adds a small noise vector to every word vector generated by the embedding layer. Note that FIG. 24 depicts the FIG. 21 DL model with the inclusion of the noise layer 2401. Similarly, the noise layer 2401 can also be inserted in the model drawn in FIG. 14. Note that, regardless of the augmentation method applied, at each epoch of the training, a new augmented version of the training dataset is used for training the DL model.

### Machine Learning Models

A few non-limiting exemplary embodiments for FIG. 21 DL models that work well for the purpose of contextual analysis of legal documents are now presented. Specific functionality and performance described may be altered by making small modifications such as adding a new layer, deleting an existing layer, or changing the type/structure of a layer, all of which are contemplated as part of the present invention.

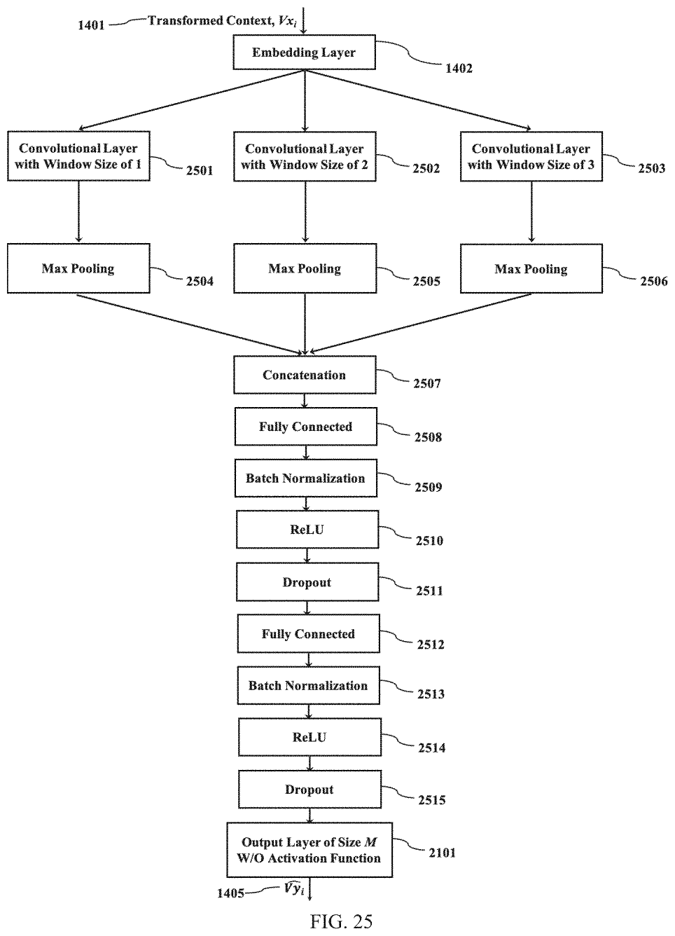

FIG. 25 shows a multi-branch convolutional neural network (CNN) with a fully connected feedforward neural network that may be used as part of the fully trained and deployed research system 104. A CNN is a type of DL model that can learn the spatial or the temporal patterns and features in data. They can be very helpful in learning the training dataset because they can learn and model the factual patterns and the features among the contexts and how these features and patterns are related to different possible laws. A CNN usually has a window, also called a filter, that slides over the data to process the portion of it seen through the window for feature extraction. A property of the window is its size that for text data is in fact the number of words allowed to fit. Usually a CNN model has many copies of same same-sized windows. Each window is trained to detect and pick up a different feature and pattern. But there are also variants of CNNs that have windows of different sizes.

Referring to FIG. 25, the input going into the model may be the context in the form of a sequence of indexed words. In some embodiments, the size of this sequence may be 40. in some embodiments, the first layer of the model may be an embedding layer 1402. Embedding layer 1402 may be a Word2vec, GloVe, ELMo, or any other similar word representation model. In some embodiments, Word2vec method is used and the size of the word vectors in this embedding layer 1402 may be 256. In some other embodiments, ELMo method is used and the size of the word vectors in this embedding layer 1402 may be 1024. The pretrained ELMo model can be downloaded from TensorFlow Hub. Using the input argument “elmo” to this model, ELMo provides a separate word vector of size 1024 for each word in the input. Note that usually needs the inputs to be in the form of original words, not transformed to indexes and numbers. In such cases, before providing the sequence VXᵢ of indexes to ELMo, the sequence of indexes is simply transformed back to the corresponding sequence of words xᵢ.

In some embodiments, there may be a CNN layer after the embedding layer 1402. In some embodiments, there may be multiple CNN layers in parallel (multi-branching), each with possibly a different window size. Layers 2501, 2502, and 2503 are three exemplary such CNN layers. In some embodiments, the sizes of CNN windows for layers 2501, 2502, and 2503 may be 1, 2, and 3, respectively. There may be many copies of these windows, in some cases, the number of copies can be 100. In some cases, there can be pooling layers 2504, 2505, and 2506, after the CNN layers. The outputs of these parallel pooling layers can be concatenated to build a single feature vector for the context.

The feature vector produced by CNN models may be processed with a feedforward neural network to map the feature vector extracted from the context to an output vector in the continuous state space, restoring some legal citation (law) after being decoded. This feedforward neural network may be layers 2508, 2509, 2510. 2511, 2512, 2513, 2514, 2515 and 2101. These may be fully connected feedforward neural network layers, such as:

Layers 2508 and 2012, where the number of neurons in each layer may be 512;

Batch normalization layers, such as 2509 and 2513, which be added to increase the stability of the network;

Dropout layers, such as layers 2511 and 2515, which may be added to prevent overfitting (in some cases, the dropout rate of these dropout layers may be 0.1);

ReLU layers 2510 and 2514, which may be added to the network as nonlinear activation functions.

In some embodiments, the output layer 2101 may be composed of M neurons with no activation functions. In some embodiments, M may be 256. During testing, FIG. 25 DL model proved to be a very capable model to learn the factual patterns for different laws.

Note that the FIG. 25 exemplary architecture considers laws as the continuous-valued entities, and therefore outputs a continuous-valued vector to estimate them. In some embodiments, the FIG. 25 architecture may be adjusted to predict laws as discrete labels by replacing output layer 210 with a softmax layer.

FIG. 26 shows another exemplary DL model which is capable of learning a training dataset and operating as a research system, which utilizes:

A recurrent neural network (RNN) to extract important features and patterns from the sequence of words;

Attention layers to cast special attention on important parts of the sequence;

A feedforward neural network to map these attended features to an output vector for predicting the relevant laws for a given input context.

RNNs are ML models with an internal memory, which are capable of simultaneously learning the important features and forgetting the irrelevant details from a sequence of processed data. This characteristics of RNNs make them a good candidate for extracting valuable patterns from legal text as well. Also, a bidirectional RNN could be used, which is basically made out of two RNNs. The first RNN receives the input sequence in one direction while the other one does so in the reversed direction. The internal states of individual RNNs at each timestep can be concatenated to produce the total internal state of the bidirectional RNN at that step. Different RNN models are known, such as LSTM, GRU, etc. Attention mechanism is one of the latest innovations in the field of DL, which allows the machine to pay close attention to certain parts of a sequence of data. This enhances the performance of a research system in finding relevant laws based on the features extracted from the contexts that carry heavier legal weight.

Referring to FIG. 26, the context going into the DL model may be in the form of a sequence of indexed words. In some instances, the size of this sequence may be 40. The first layer of the model may be an embedding layer 1402. In some cases, the Word2vec method is used and the size of the word vectors in this embedding layer 1402 may be 256. In other cases, the ELMo method is used and the size of the word vectors in this embedding layer 1402 may be 1024. In still other instances, there may be a bidirectional RNN 2601 following immediately the embedding layer 1402. The size of individual RNNs in the bidirectional RNN may be 256.

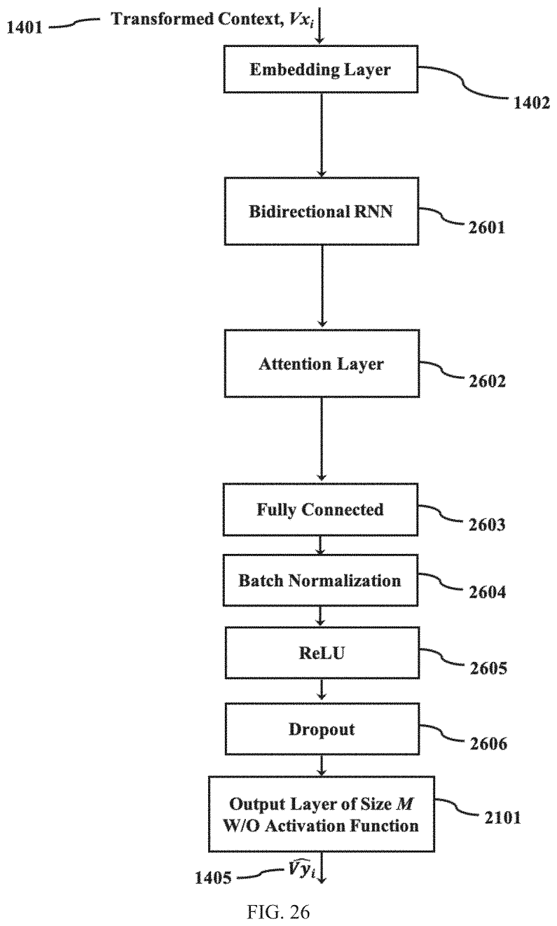

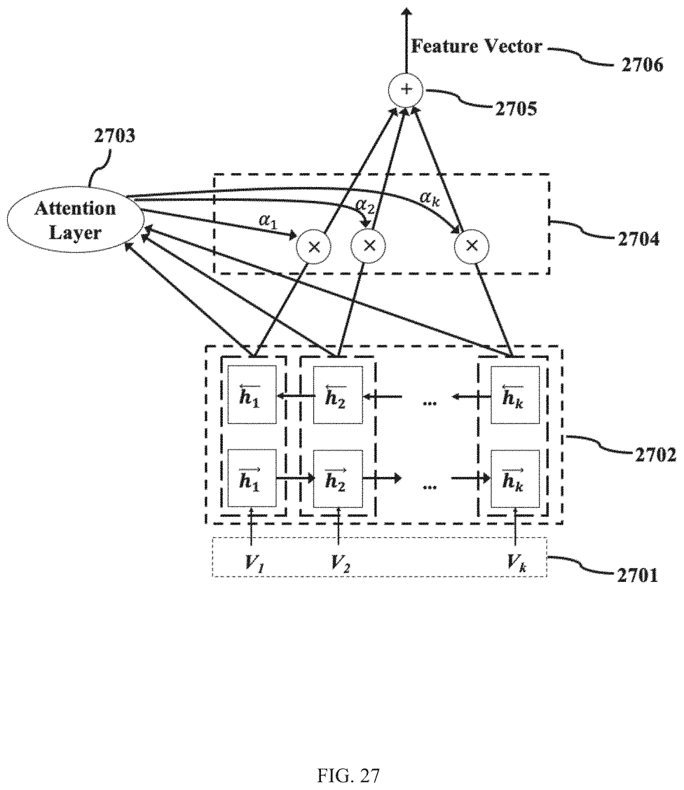

An attention layer 2602 may be used after the bidirectional layer. FIG. 27 shows one such example that is used in combination with a bidirectional RNN layer. Referring to FIG. 27, box 2701 is a sequence of context words in terms of word vectors Vᵢ for i∈{1,2, . . . , k}, where k is the length of the sequence. Vᵢ can be produced by the embedding layer in 1402.

The bidirectional RAN 2702 may be unrolled over time, Note that there are two RNNs stacked on top of each other. \vec{h}ᵢ is the internal state of one RNN at step i, and [symbol] is the internal state of the second RNN at step i.These two internal states concatenated, [\vec{h}ᵢ, [symbol] ] represent the internal state of the bidirectional RNN at step i.

The attention mechanism 2703 receiving the internal states of the bidirectional RNN at all steps. It produces a coefficient (weight) for each internal state—also called attention coefficient—which measures the amount of attention to be given to them. The main reason behind introduction of attention mechanism is that not all words contribute equally to the representation of the sentence meaning. The attention coefficients are given by,

$${α}_{i} = \frac{exp ( {u}_{i}^{T} c )}{{Σ}_{i} exp ( {u}_{i}^{T} c )} , \\ where , {u}_{i} = tanh ( W {h}_{i} + b ) .$$

Here, the values of the vectors W, b, and c are all learned during the training process.

Process 2704 multiplies the attention coefficients αᵢ by hᵢ that means every internal state is weighted by the amount of attention received. Processes 2704 and 2705 calculate the sum of the weighted internal states, which gives the feature vector 2706 (final output of FIG. 27). More information on the attention mechanism can be found in Z. Yang et al., “Hierarchical Attention Networks for Document Classification,” Proceedings of the 2016 Conference of the North American Chapter of the Association for Computational Linguistics: Human Language Technologies (2016).

The feature vector in FIG. 27 is the output of the attention layer that represents the important patterns in the context. Shown in FIG. 26, the DL model is a feedforward neural network responsible for mapping the feature vector produced by the attention layer to an output vector. More specifically, in some cases, after the attention layer there may be a fully connected feedforward layer, which is shown as layer 2603. The size of the fully connected feedforward layer may be 256. A batch normalization layer 2604 may be placed after the fully connected layer. A ReLU activation layer 2605 may be placed after the fully connected layer. A dropout layer 2606 may be placed after a batch normalization layer. The 2101 output layer may be composed of M neurons with no activation functions, therefore producing a continuous-valued vector as the predicted law for the context input, where M may be 256.

The language models such as word2vec, GloVe, ELMo, or other similar language models take words from a sentence and produce a word vector—a feature—for each word. The deep neural network 1403 is an architecture that is used with these language models to take different word vectors for different word in the sentence, and to combine and process them for the purpose of performing the down-stream task. FIG. 25 and FIG. 26 DL models introduce two example instances for how these word representations can be combined to perform the downstream task of estimating the relevant laws.

BERT (J. Devlin et al., “Bert: Pre-training of Deep Bidirectional Transformers for Language Understanding,” arXiv preprint arXiv:1810.04805 (2018)) and OpenAI's GPT (K. Radford et at, “Improving Language Understanding With Unsupervised Learning,” Technical Report, OpenAI (2018)) are two examples of language models and representations that take the entire sentence and model and represent it in a manner very suitable for the down-stream applications. The BERT model is a multi-layer bidirectional Transformer encoder. The transformers, which were originally in A. Vaswani et al. “Attention is all you need,” Advances in Neural Information Processing Systems (2017), are an important building block of many other language models as well.

Models such as BERT are so gigantic that they require a large amount of data and compute power to train their many parameters. If the size of a database, such as a legal corpus, is large enough, one may train these models from the scratch on the available data that the research system 104 is supposed to explore. Otherwise, a pre-trained version of BERT or other similar models could be potentially sufficient, requiring just a small fine-tuning with one additional output layer.

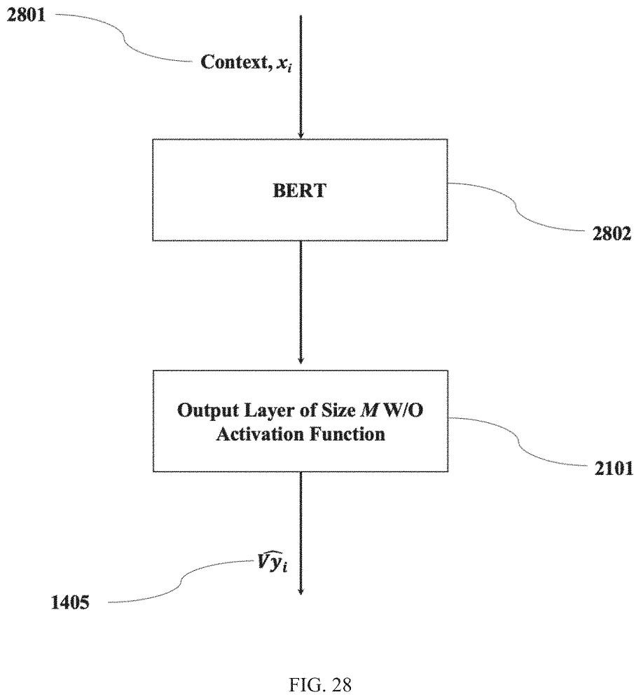

FIG. 28 shows an exemplar embodiment for BERT when used as a ML model to operate as a research system. Just like ELMo, a BERT layer 2802 receives the 2801 sequence of words, xi, not the sequence of indexes. There is an additional layer 2101 that sits in front of BERT and transforms the BERT outputs to estimate 1405, i.e., estimated law, [symbol] ᵢ. BERT can be used for both classification as well as regression problems. When considering law as discrete classes, the layer after BERT can be a softmax layer or other similar output layer treating outputs as classes. Alternatively, the output layer 2101 can produce a dense continuous-valued vector, which regards laws as continuous entities in a state space. The exemplary embodiment of FIG. 28 treats laws as such. That is, BERT with a softmax layer can be used as a research system that classifies the context into different law classes.

The continuous-valued laws and the output vectors [symbol] ᵢ may exist in the same state space. Language models such as Word2vec, which assign a word vector for each word, including the tokenized laws, may be used to transform the laws into vectors in this state space. The laws that are close to [symbol] ᵢ can be deemed relevant to 2801 context input, xi. The process to train a pretrained BERT-based DL model to operate as a research system is pretty much similar to other DL models introduced so far, and FIG. 16 training method can be used to fine tune this DL model.

So far, the machine learning models have been trained with supervised learning. A labeled training data set is extracted from the case files, which shows which laws have been applied to different contexts, and the model is trained to predict these laws given a context. This approach can be also called a semi-supervised learning. In self-supervised learning, which is a form of unsupervised learning, the data itself provides the supervision. Basically, mask or withhold a portion of the data, and let the model learn and predict the masked piece of the data. For example, mask the law, and let the model predict the law given the visible context—explained above, but under the name of supervised learning. As a result, regardless of which terminology or point of view is used, all terminologies and forms of learning, namely supervised learning, unsupervised learning, and self-supervised learning, when it comes to training a machine learning model to learn the law, are contemplated as part of the present invention.

### Ensembling

A hybrid model, developed by “ensembling” several ML models, may be employed for the purpose of enhancing performance of the research system 104. These models may either be different but trained separately on the same training dataset or be similar but trained on different parts of the training dataset. In such embodiments, the output of the ensemble models may be an aggregation of the individual outputs from the models. The aggregated outputs might be in ore accurate than the individual outputs

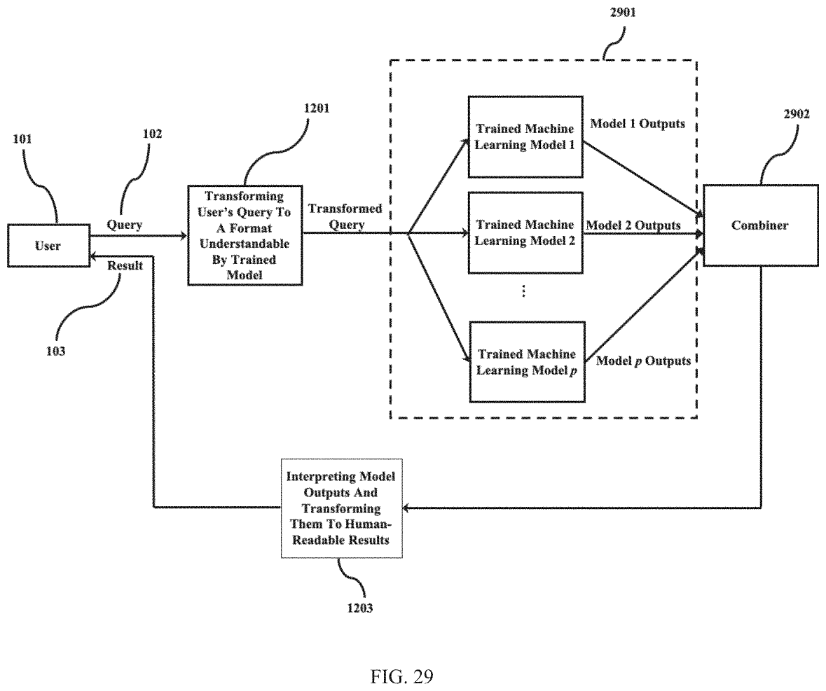

FIG. 29 shows an exemplary scenario, where 2901 is an ensemble of trained ML models that can be used as a research system. In some embodiments, each model may receive a query from the user 101 and produce an output. In some embodiments, combiner 2902 may combine and aggregate the outputs into a single output. In some embodiments, combiner 2902 may be a majority wins mechanism, which selects the laws predicted to be relevant by the majority of the models. In some embodiments, combiner 2902 may be an averaging mechanism that outputs the average of continuous-valued dense vectors.

There are steps that needed to be taken after training a model to check its performance on the unseen, hold-out test dataset to check whether the model can generalize beyond the training dataset or not. Such trained models perform well on the test dataset.

### Trained Model Deployment

These ML models trained over the records of the database 105 are ready to be used as a research system. These ML models were trained to locate important contextual patterns of facts within the contexts regardless of the language and the choice of the words or presence or absence of irrelevant details in the context, and to assign relevant laws to them accordingly. Therefore, these ML models will manage to carry over the same important capabilities into the research system 104. They can spot important contextual patterns within the user's query 102 and return the relevant laws. The exemplary diagram of FIG. 12 shows one possible method to use these trained models. After disclosing very powerful DL models that could perform much better than the classic ML models, it is a good time to revisit the diagram in FIG. 12 to discuss it in the context of DL. The new added features and capabilities that the research system 104 might have are disclosed as well.

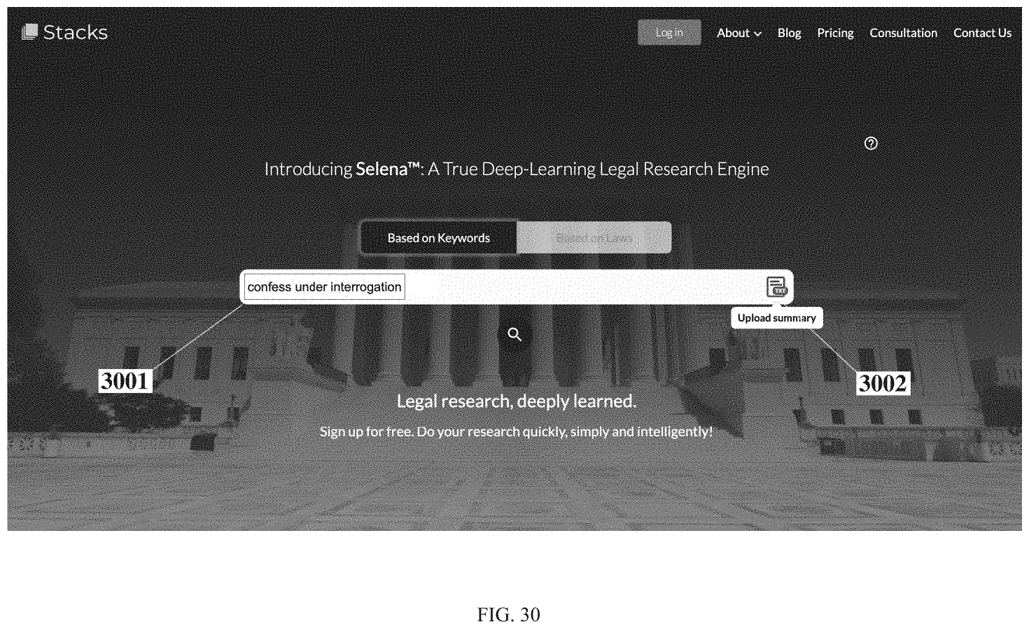

The user 101 describes the search query as a sequence of keywords or a summary of facts. FIG. 30 is a screenshot from an exemplary system implementing a human-computer interface (here, a graphical user interface), also known as a front end. The user 101 has two options, enter the keywords or a summary of facts into a text box 3001; or use upload button 3002 to upload a text document that contains a summary of the facts or keywords.

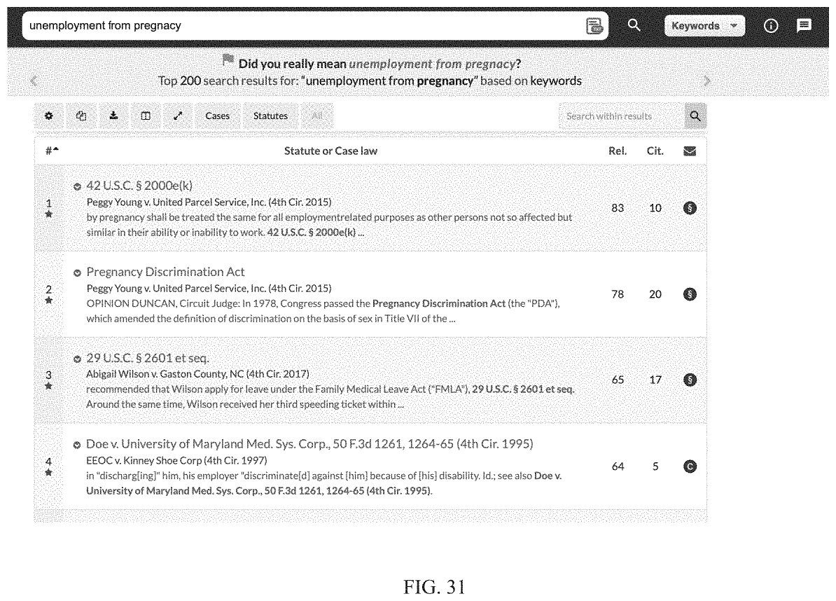

The backend (consisting of suitable hardware and software, such as data request handlers, load balancers, web servers, data servers, etc.), receives this information and performs some basic preprocessing and checking. For example, a spell-checking method checks the user's query 102 word by word against a vocabulary of words that contains all words from the records of the database 105. If a word from the user's query 102 does not exist in the vocabulary, there is a good chance that the user 101 might have misspelled it. The spellchecking method flags down the misspelled word, replacing it with the word closest to it from the vocabulary. The results for the corrected query are then shown to the user 101 while the original query is still suggested to be searched. FIG. 31 is a screenshot of the research system 104 for an exemplary implementation. One could alternatively use a standard. English dictionary to locate the misspellings, but such standard dictionaries may lack terms of art that are commonly used in a particular field. Therefore, creating a custom vocabulary from the database 105 is superior to off-the-shelf dictionaries.

In the back end, the query, which can be either in its original form or in a corrected form, may be transformed into a format suitable for ML. In some embodiments, this transformation may be the same transformation that was used to transform the contexts of the training dataset into a ML-friendly format. FIG. 32 shows an exemplary flow chart that may be used for this transformation.

Step 1301 removes unnecessary, non-informative characters and words from the query.

Step 1302 converts the context to a fixed-size sequence of indexes. Steps 1301 and 1302 are the same steps used in FIG. 13, which perform the same tasks. The trained ML model receives the transformed query. If the ML model is a classifier that treats laws like a label (FIG. 14), the output of the model is a probability for each possible law. A law that the model deems more relevant, is given a higher probability, whereas an irrelevant law gets a low probability. Step 1203 in FIG. 12 sorts the laws based on their assigned probabilities and selects the laws that their probabilities are above a predefined threshold.

If the ML model considers laws as continuous-valued dense vectors (FIG. 21), the output is going to be a vector in an M dimensional state space. In this case, step 1203 receives this vector and finds all the laws close to this output vector. The found laws are sorted based on their proximity to the output vector. In some embodiments, proximity measures such as cosine similarity may be used as a quantifier to measure the distance between the output vector and the word vectors of different laws. Step 1203 uses a predefined threshold value as a cut-off for proximity measure and selects the laws that their proximity to the output is above this threshold value.

Step 1203 in FIG. 12 also casts each law in the list of sorted found laws into its full Bluebook format. The final list is sent to the front end also called user interface along with the probability value or proximity measure for each law. The from end receives this list and shows it to the user 101.

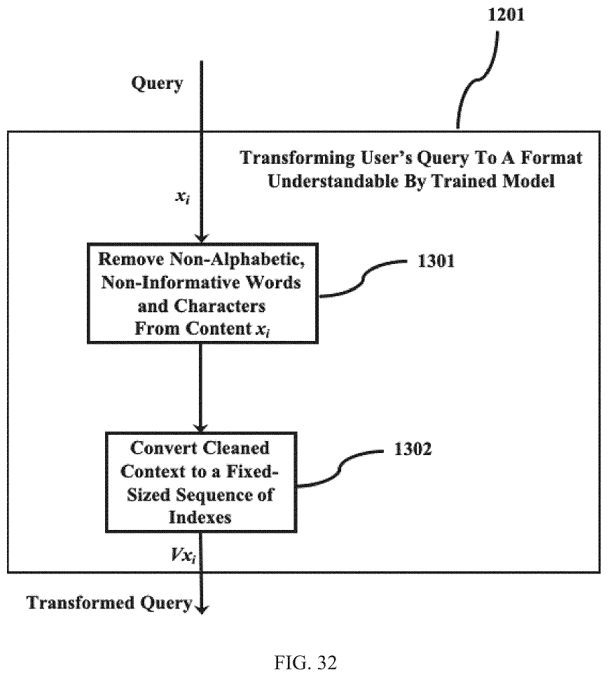

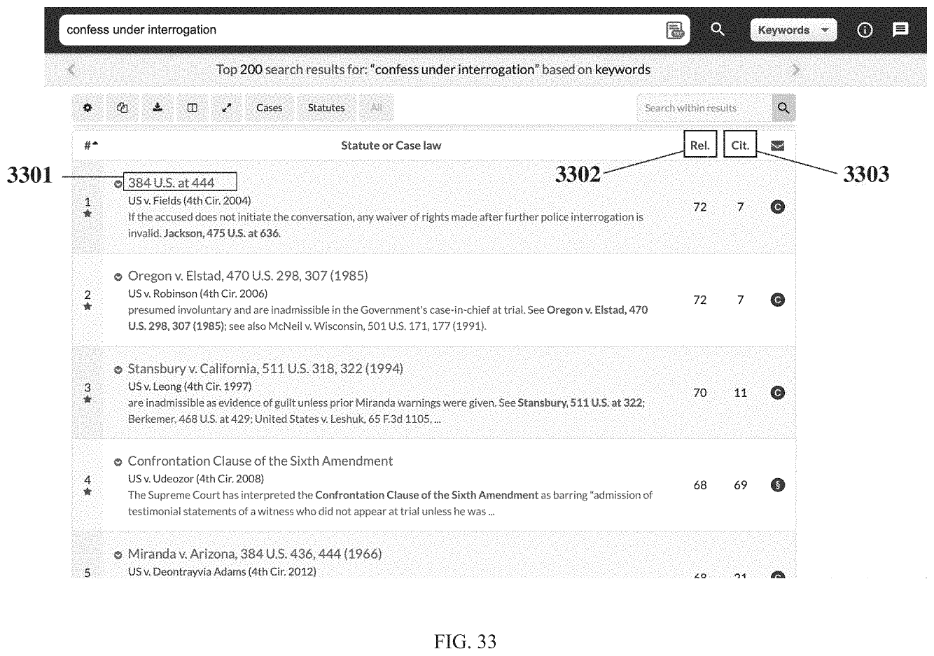

FIG. 33 is an implemented for the front end. The relevant law 3301 is returned by the model. The “Rel.” value 3302 for each is basically is the probability, or the proximity measure, based on the output of the DL model. The “Cit.” value 3303 for each law shows the number of times that law has been cited in the records (here, 4th Circuit Court cases).

In addition to the relevant laws, this research system returns example excerpts for each law, showing how the law has been applied to situations similar to the one explained by a user using a query. These excerpts could be contexts in which the law was applied in the court's prior rulings. Each law may have been cited many times in different contexts, and some contexts could be legally closer to the received query than others.

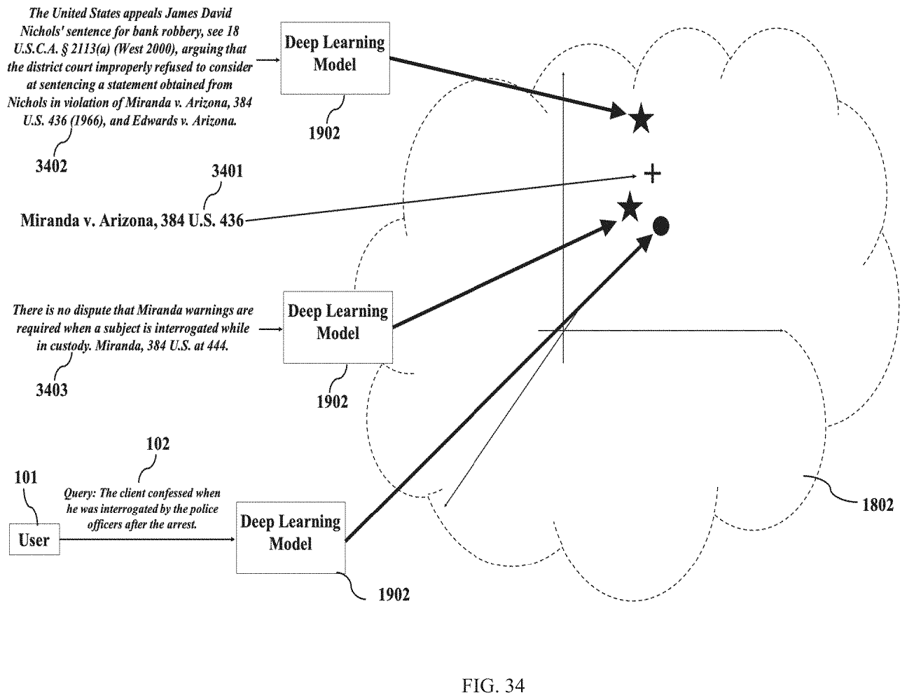

FIG. 34 shows an exemplary visualization involving finding similar contexts. As shown, the user 101 enters a query explaining a situation. The user's query 102 states, “The client confessed when he was interrogated by the police officers after the arrest.” The trained DL model 1902, which is acting as a legal research system 104 receives this query and outputs a vector in the state space 1802, where all the laws are located. A circle in the state space marks this query in the state space. This output vector is very close to Miranda v. Arizona, 384 U.S. 436, marked as 3401, which is shown by a cross symbol in the state space. Therefore, the research system 104 returns Miranda v. Arizona, 384 U.S. 436 as a top relevant case law, which has been cited in the court cases many times.

Boxes 3402 and 3403 show a couple of sample contexts in which this case law was cited. The same trained DL model 1902 may be used to map these contexts into the state space 1802 as well. Two stars mark these mapped contexts in the state space. In some instances, the mapped contexts that are closer to the mapped query can be chosen as the more relevant excerpts. The main idea behind this method is that the trained model looks for the patterns within the input, and maps contextually similar inputs to close-by points in this state space. As a result, this provides a systematic method to pick excerpts related to the query and show them to the user 101 in the from end. Reading the two example contexts in FIG. 34, one can easily notice that the context in 3403 is closer to the query than the 3402 context. This observation is consistent with the results obtained from the model.

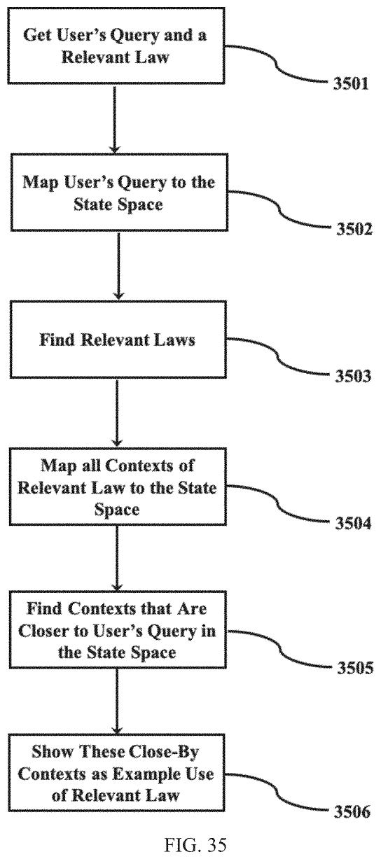

FIG. 35 is an exemplary step-by-step flow chart for finding similar sample excerpts. In step 3501, get the user's query 102 and a relevant law. In some embodiments, the relevant law may be produced by the trained ML model that is operating as a legal research system.

In step 3502, using the named model map the user's query 102 to a state space. In some embodiments, this state space may be the same state space that all laws are mapped to.

In step 3503, find all relevant laws according to their proximity to the output of the trained model.

In step 3504, get all contexts for a relevant law, and using a trained map, maps them to a state space. In some embodiments the trained model may be the same model that is used to map the user's inquiry to the state space. In some embodiments, the state space may be the same state space that the user's query 102 and the laws are mapped too.

In step 3505 find the mapped contexts that are closer to the mapped query of the user 101. In some embodiments, cosine similarity may be used to find the close-by contexts in the state space.

In step 3506 return the close-by contexts and show them to the user 101 as the application of the relevant law in the contexts similar to the site explained in the query.

The exemplary FIG. 34 also supports the fact that a research system that comprehends the user's query 102 and returns relevant laws with some excerpt(s) explaining how they can be applied to the situation expressed in the query, goes beyond the definition of a legal research system, and enters the realm of a virtual legal assistant. The trained model maps 3403 excerpt “There is no dispute that Miranda warnings are required when a subject interrogated while in custody. Mirada, 384 U.S. at 444,” to the user's query “The client confessed when he was interrogated by the police officers after the arrest.”—Some aspects of this invention can, as a result, be used as a foundation for a virtual legal assistant.

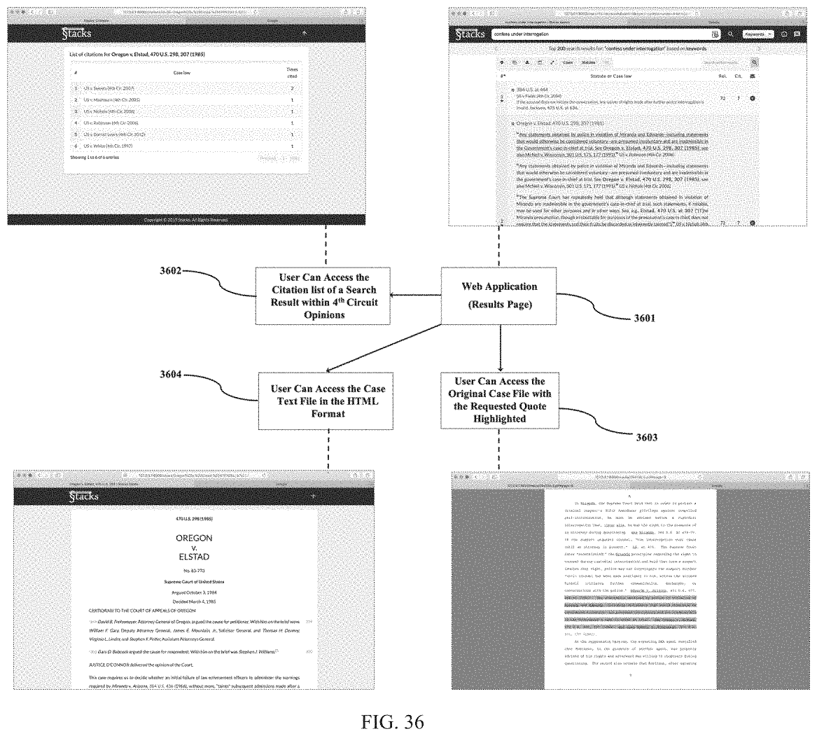

FIG. 36 is a diagram of an exemplary user interface. The results page 3501 of the web application designed to receive a query or summary of facts in the form of a string or text file from the user 101 and return a list of laws closest to the query or summary text. Here, the example query shows that the user 101 has entered “confess under interrogation”. The output is a list of all the relevant laws and the user 101 has clicked on the second result. Then, a list of five excerpts for each citation (quotes) from five different cases in the 4th Circuit Court is shown that includes the cited case in the result header. 3602 shows a list of citations for the chosen result that the 4th Circuit Court has cited in different cases since 1990s until 2019. Here, seven cases are in the docket that have cited the chosen result by the user 101. User can click on either one of the shown cases to open and search through the chin case. User can click on either quote that contains the chosen citation to open the case exactly at the page that includes that quote highlighted. This highlighting process is done in real time using a quote-for-highlight system specifically developed in this research system to open the original pdf file of the case and highlight the portion most relevant to the query. This is summarized in 3603 with a sample result page shown. Another aspect of this invention is a system that directly shows the user 101 where the quotes are in the original case file as opposed to many existing systems that only refer the user 101 to a secondary outside manipulated source. 3604 shows that, user can also open the case file of the citation shown in the result header.

Not all citations in court cases follow the Bluebook format. It is often a writer's discretion to cite a law in an abbreviated or a non-standard form, depending on the nature of the writing. If this problem is not attended and corrected, the same law may appear in multiple different versions in the training dataset, and the algorithms will be treating them as separate laws. Furthermore, in the result page, the user 101 may observe the same law multiple times as different results under slightly different formats, and this may degrade the user experience as well.

FIG. 37 shows an exemplary, step-by-step flow chart for handling such a situation. In step 3701, a set of all laws are provided. In some embodiments, this list may be produced by step 308 in FIG. 3. Step 3702 reads a law from this list. In the rest of the description of FIG. 37 this law is called “the law under study.”

Step 3703 finds all laws that are contextually similar to the law under study. In some embodiments, this may be done by taking the vector representations of the laws, where the contextual similarity of the laws is transformed to their proximity in a state space and finding the laws that their vector representation is close to the vector representation of the law under study. In some embodiments, Word2vec model may be used to represent each law as a word vector. In some embodiments, cosine similarity may be used as a method to measure the proximity.

Step 3704 finds the laws that are lexically close to the law under study as well from the list of contextually similar laws to the law under study. Note, than when determining the lexical similarity of laws, the text of the law citation is investigated as a sequence of characters and words, not their vector representations. In some embodiments, the lexical similarity may be measures in terms of Levenshtein distance.

In step 3705, the laws that are both contextually and lexically similar to the lay under study may be consolidated into a same law. In this process, both lexical as well as contextual similarity between two laws need to be considered in order to decide whether they are the same or not. There are separate laws that might be lexically very similar. Contextual analysis would help to distinguish such lexically similar laws from each other. Also, two separate laws could be contextually very similar. Lexical analysis could help to distinguish them.

In step 3706 of the flow chart, it is checked whether all laws in the set are read and investigated or not. If not, the process goes to step 3702 and reads a new law. Otherwise, the flow chart ends in step 3707, where an updated set of laws is prepared in which different variations of the same law are consolidated into a single law.

### Nearest Neighbor Search

There may be situations where laws in the database 105 have not been cited enough so that the DL model may not learn a robust and accurate representation for them. Furthermore, including such laws with very few contexts in the dataset can negatively downgrade the overall training of the DL models and the resulting research system 104 that uses the model. During preparing the training dataset in some embodiments, a minimum citation number may be defined for the laws. Those laws that have been cited equal to or greater than this minimum number are included in the training dataset, and those that fail to meet this requirement are excluded from the training dataset. This modified training dataset may be used for training the DL model, and the resulting research system will return the relevant laws from those laws that have met the minimum citation requirement. However, there might be some relevant laws among, the excluded laws from this training dataset. An alternative ML technique may be used in such situations to explore these lowly-cited laws and return the relevant ones. In some embodiments for the research system 104. this special ML technique for lowly-cited laws may work in conjunction with the DL models, and the results are going to be a combination of relevant laws produced by both systems.

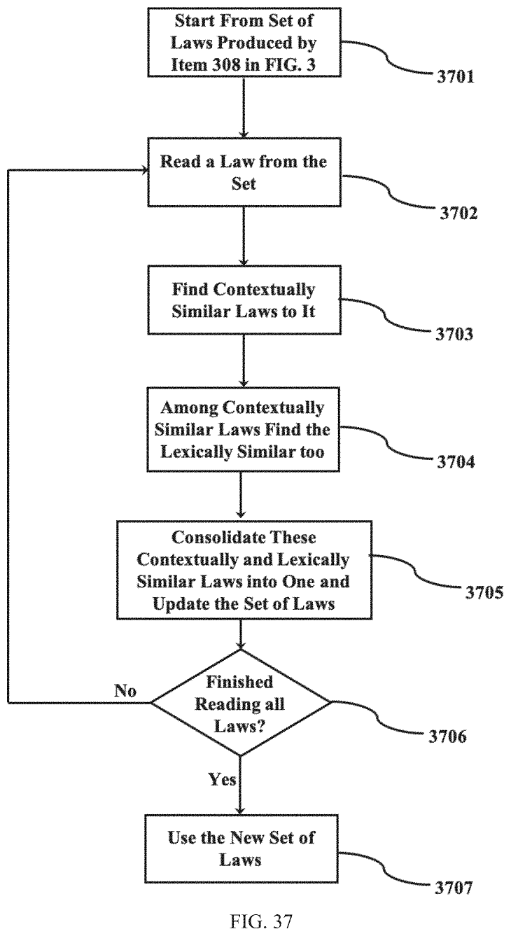

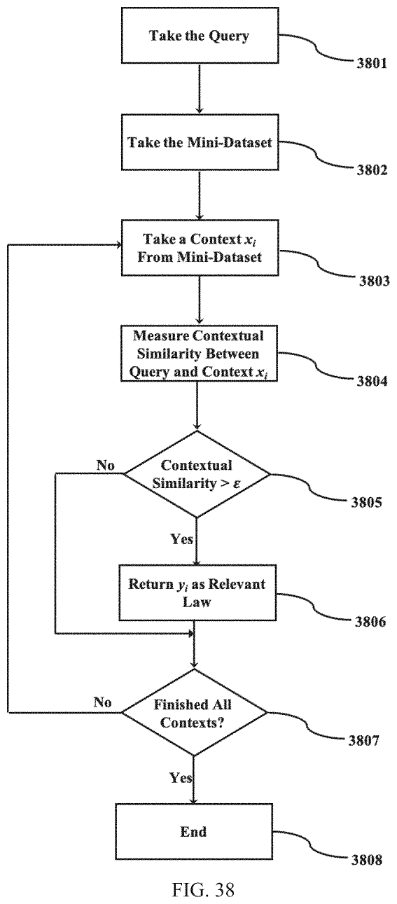

FIG. 38 shows an exemplary flow chart for how this ML technique may operate. This special ML technique is model-free in the sense that no model is fitted to the training dataset. Instead, the training dataset would be directly used to find the relevant laws.

In step 3801, the query is received. In step 3802, a training dataset that is composed of (xᵢ, yᵢ) where yᵢ is a lowly-cited law is provided. This training dataset is called a mini training dataset, or simply mini-dataset. In step 3803, a context xᵢ from the mini dataset obtained. Step 3804 measures the contextual similarity between the context xᵢ and the query, and if the similarity is above a predefined measure, the law yᵢ will be selected as a relevant law.

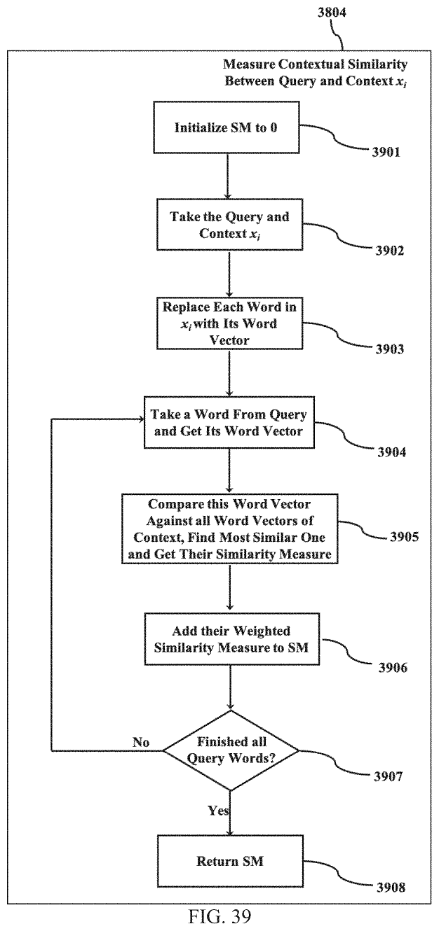

FIG. 39 flow chart shows an exemplary flow chart for how this contextual similarity measure may be calculated. Referring to FIG. 39, step 3901 initializes a variable SM to 0, where SM stands for similarity measure.

Step 3902 takes the query and the context xᵢ to find their similarity measure.

Step 3903 replaces each word in the context xᵢ with its word vector. In some embodiments, the word vectors for the words may be Obtained from exemplary FIG. 15 flow chart using methods such as Word2vec.

Step 3904 takes a word from the query and finds its word vector. The word vectors for the words may be obtained from exemplary FIG. 15 flow chart.

Step 3905 compares the word vector of the chosen word from the query against the word vectors of all words in the context xᵢ, finds the most contextually similar word from the context, and calculates their similarity. Mathematically, step 3905 can be implemented as follows:

$${θ}_{k} = {max}_{j} C ( {Vq}^{k} , {Vx}_{i}^{j} )$$

where Vq^{k} is the word vector of the word chosen from the query in step 3904, Vxᵢ^{j} is the word vector for the jth word in the context xᵢ, and j goes from 0 to 1 with 1 being the length of the context. The function C can be any contextual similarity measure defined for the word vectors, including, but not limited to cosine similarity. Θₖ is indeed the contextual similarity measure of the closest word in the context xᵢ to the word selected from the query in step 3904. In some instances, instead of finding the similarity measure between the most similar word in the context with the word from the query, the collective contextual similarity measures between all the words in the context with the word from the query may be calculated. As an example, this could be done in the following way:

Θₖ=ΣⱼC(Vq^{k},Vxᵢ^{j}).

in which the similarity measures for all different words in the context are added together. The only issue with this method is that the similarity measure is proportional to the length of the context. In one approach, this problem may be addressed by normalizing the collective similarity measure, that is, dividing it by the length of the context (number of words). So far, only the similarity measure between one word from the query and the context xᵢ is calculated.

Back to the flow chart in FIG. 39, in step 3906 similarity measure calculated in step 3905 may be added to SM.

Step 3907 checks whether they have performed this process for all the words of the query or not. If not, go back to step 3904 and take another word from the query and repeat this process. Otherwise, if this process is performed for all the words from the query, SM is the contextual similarity measure between the query and the context and the flow chart returns SM.

Back to FIG. 38 flow chart, if the contextual similarity between the query and the context xᵢ is greater than a predefined measure, the relevant law xᵢ along with its contextual similarity measure will be presented to the user 101.

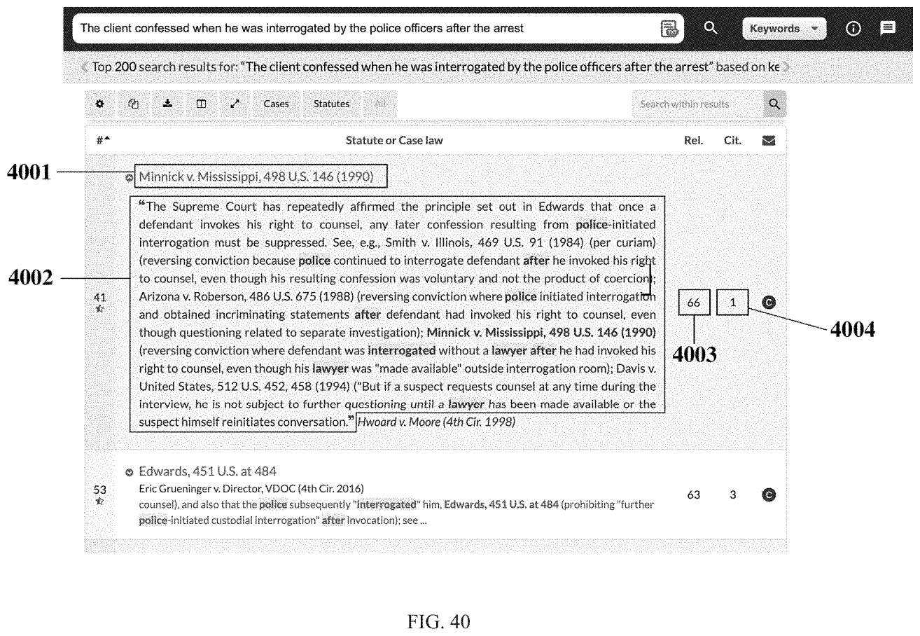

FIG. 40 shows a screenshot from an exemplary implementation. In FIG. 40, 4001 shows the relevant law yᵢ, 4002 is the context xᵢ for yᵢ, 4003 is the similarity measure between the query and the context xᵢ, and finally 4004 is the number of times yᵢ has been cited in the 4th Circuit Court cases. FIG. 38 flow Chart repeats this process over all contexts in the mini dataset. More specifically, in step 3807, some embodiments may check if they have finished going over all the contexts or not. If not, some embodiments may go to step 3803 and read a new context, otherwise the flow chart ends.

One potential issue with this method and equation could be the presence of irrelevant, uninformative words in the query. Imagine a user adds a lot of common words that do not specifically narrow down the domain of research, and those words could show up in many other contexts. Deep learning models trained over the training dataset could learn to pick and choose the important features and factual patterns from the input and neglect the relevant parts. But here there is no such DL model to perform automatic feature selection. As a result, somehow the effects of such words need to be discounted. This could be done by introducing a weight factor for each word in the vocabulary depending on how informative and discriminative they are. These weights may be used to discount Θₖ values of indiscriminative, uninformative query words. More specifically, some embodiments may calculate the weight ω for a word d as follows:

$${ω}_{d} = 1 - \frac{{n}_{d}}{N} ,$$

where n_{d} is the number of contexts in the training dataset that contain the word d, and N is the total number of contexts available in the training dataset. The common words appearing in all the contexts will get a weight of 0. The rare discriminative words will get weights close to 1. Note that here the training dataset could be the whole dataset before paining the lowly-cited laws. Alternatively, some embodiments may use the following equation to compute such weights for the words, which is very similar to inverse document frequency (idf):

$${ω}_{d} = - log \frac{{n}_{d}}{N} .$$

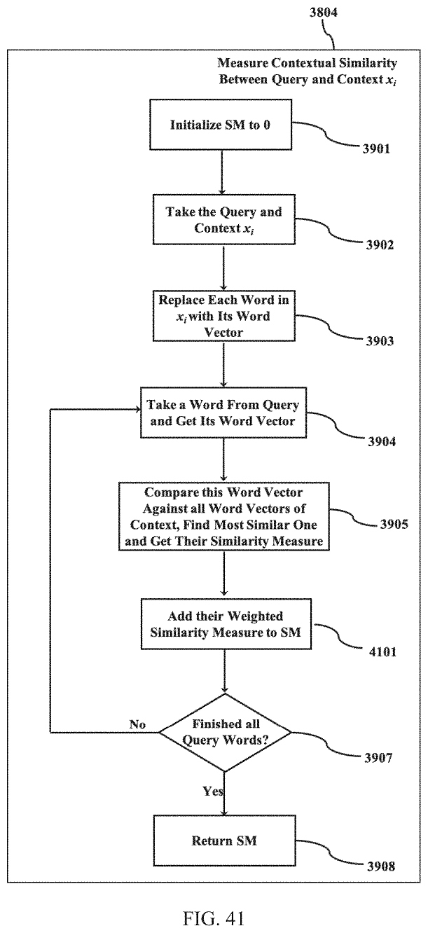

The flow chart in FIG. 41 is an alternative to the flow chart in FIG. 39, which includes these weights. Step 4101 now adds the weighted similarity measures to SM. Some embodiments may use the following equation to implement step 4101:

Θ=Σₖω_{d}_{ₖ}Θₖ,

where Θₖ is the contextual similarity measure between the kth word in the query and some context, and ω_{d}_{ₖ} is the weight of this word.

So far the user's query 102 to the research system 104 has been a summary of facts or a list of keywords that can be given to the trained ML model in order to find and return the relevant laws. Imagine a different scenario in which a user already knows a specific law that partially describes some issue. The user 101 would like to find other laws that have been used in similar situations or in conjunction with the input law. A research system that in response to a query with a legal citation could return similar laws, would be able to help the practitioner of law to discover all different legal aspects of that citation.

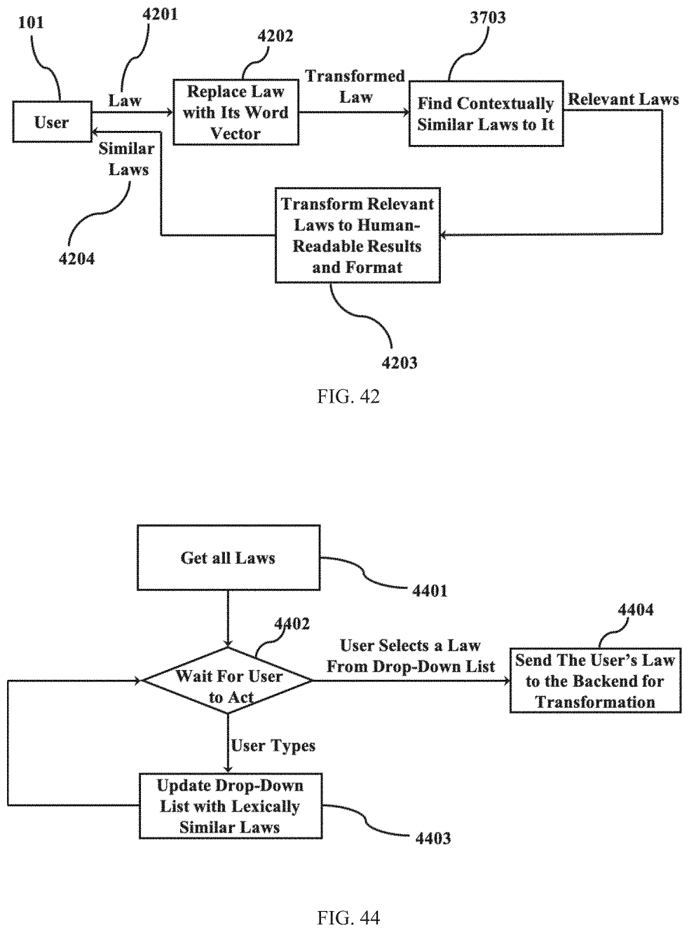

FIG. 42 is an exemplary situation, showing how this method operates. The user 101 enters the law 4201. Step 4202 transforms this law into its word vector. In some embodiments, the word vectors obtained in the diagrams 15 may be used for this purpose.

Step 3603 finds laws similar to the entered law.

Step 3703 has been used before in FIG. 37 for a similar task. It basically finds all the laws that are contextually similar to the law under study. In some embodiments, this may be done by taking the vector representations of the laws, where the contextual similarity of the laws is transformed into their proximity in a state space and finding the laws that their vector representation is close to the vector representation of the law under study. In some cases, cosine similarity may be used as a method to measure the proximity.

4203 receives the similar laws and report them back to the user 101 in their Bluebook format.

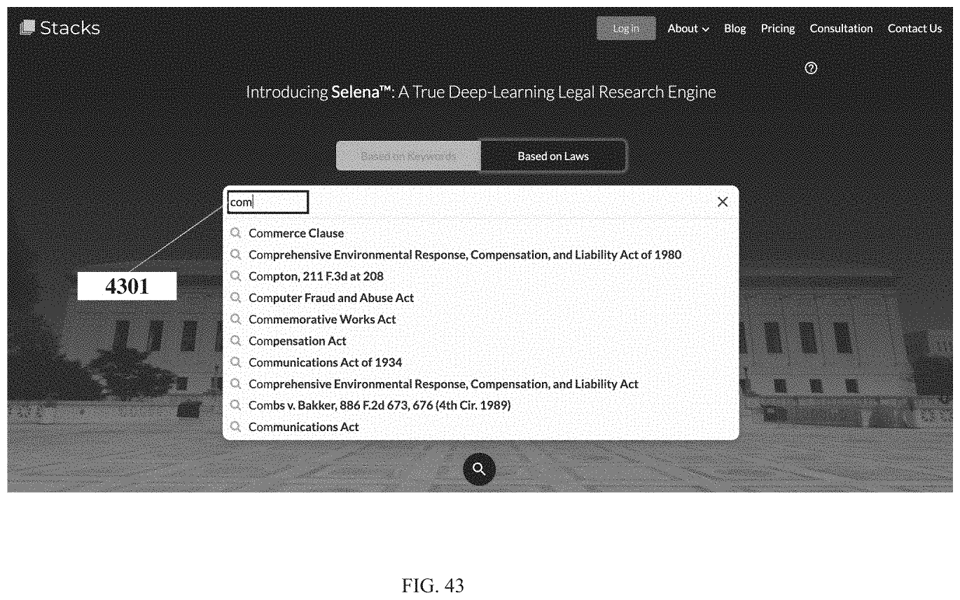

As an exemplary implementation, FIG. 43 shows a screenshot of the front end where the user 101 enters the law. Remembering a law in its full format can be a challenge for the users. As a solution, while the user 101 types in the input field 4301, the drop-down list brings up all the laws that are lexically similar to the user's input. Each time a new letter is typed in, the content of the drop-down list is updated to show laws lexically similar to the user's input. FIG. 44 is an exemplary flow chart showing how this drop-down list operates.

In 4401, all the laws observed in the database 105 are collected. This is basically the domain of all the laws that the research system 104 can accept as a valid input. The flow chart idles at state 4402, waiting for the user 101 to take action. As the user 101 starts typing, step 4403 gets activated, where all the lexically-similar laws are added to the drop-down list. The lexical similarity may be a measure of Levenshtein distance between the user's entry and all the legal citations in their Bluebook format.

After updating the content of the drop-down list, the flow chart goes back to the idle state of 4402. This process of updating the drop-down list continues as long as the user 101 keeps typing. Upon spotting and selecting a desired legal citation from the list, the front end sends it to the back end for processing, as is shown with stop 4404.

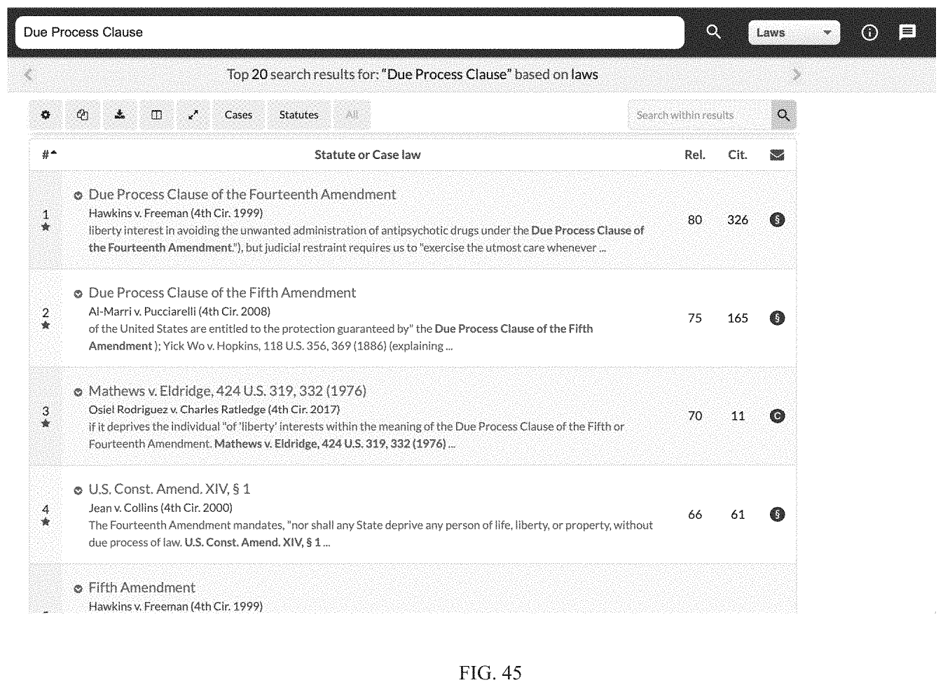

FIG. 45 shows an exemplary implementation, where laws similar to the user's input legal citation are listed.

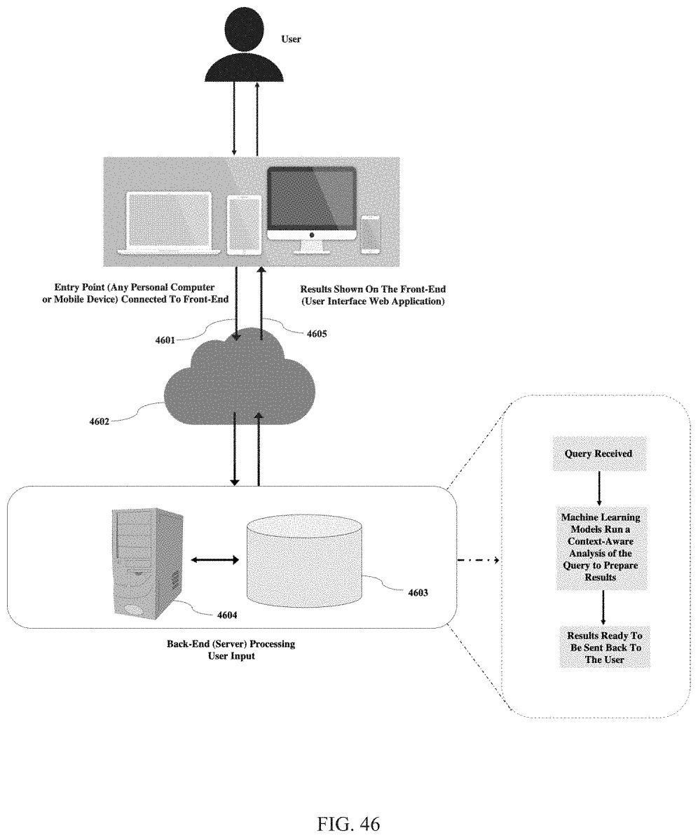

The embodiments introduced in this invention could be executed either on the client's local computer or on the cloud. FIG. 46 is an exemplary diagram for the implementation of a ML research system on the cloud. 4601 is the entry point for user's request, that is either a portable device or personal computer on which the user 101 pulls up the interface also known as the front end of the research system 104 and submits a query. Alternatively, the user may use voice commands to input the query. The system sends the query through a network 4602 to the back end for processing. 4603 is the database 105 of all the records composed of either legal documents, or patents, or scientific articles, etc. 4604 is a server consisting of a powerful computer that hosts the back-end ML system trained over all the documents in the database 105, which analyzes the query in a context-aware manner to find the results contextually related to the query. 4605 is exit point for the post-processed results to be presented to the user 101 on the user interface as text, or plays the results as audio.

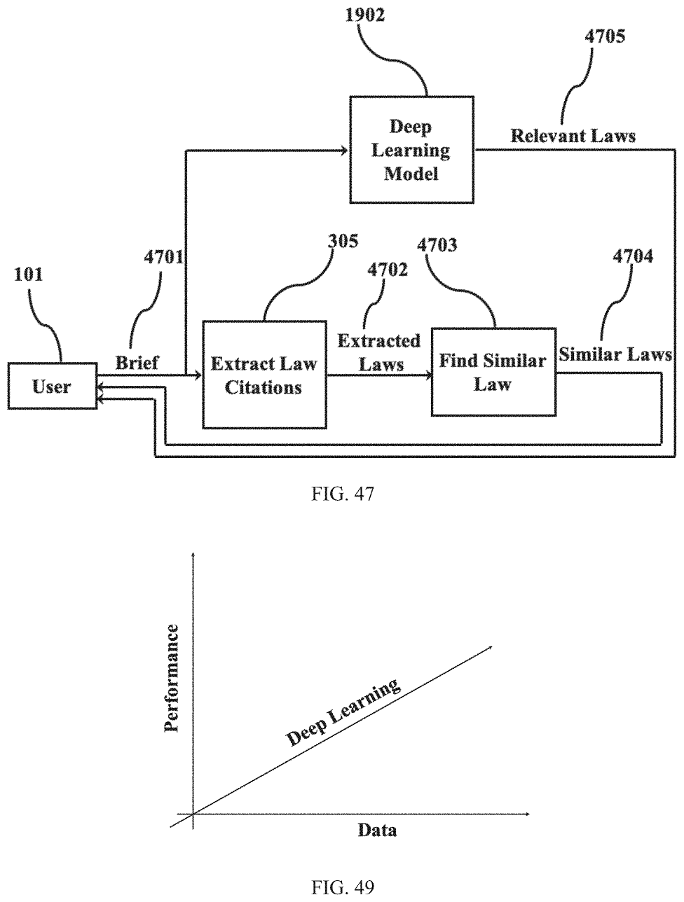

In another aspect, the presented invention can be used as a document analyzer, for example, to analyze a legal brief. In this embodiment, a user has prepared a brief, and would like to know whether proper authorities are cited based on the facts in the brief (i.e., based on the context). An ingest or input process can receive the brief from the user, dismantle it and extract all cited laws within the brief, as well as important factual patterns. As output, the system returns laws similar to the cited laws and laws relevant to the factual patterns in the text of the brief. FIG. 47 is an exemplary diagram for this brief analyzer. User 101 uploads brief 4701. Citation extractor 305 extracts all cited laws in the brief. Citation extractor 305 may be the same method module shown in FIG. 5 used for extracting the citations used in preparing the training dataset. For each extracted law 4702, module 4703 finds the similar laws 4704 and return them to the user 101 Module 4703 may be implemented by the same process shown in FIG. 42 used for finding similar laws for a given law.

The deep learning model 1902 analyzes the brief to check for the presence of important factual patterns within the text, and when it finds one, it returns relevant laws 4705 for each factual pattern. The deep learning model 1902 may be similar to or the same as machine learning model 1902 shown in FIG. 19 that is trained to learn the important factual patterns far each law, and when observed those patterns in the text, it produces the relevant laws. The deep learning model 1902 accepts a certain-sized chunk of text as its input whereas the brief 4701 can be arbitrarily long. The brief 4701 may be divided to sections, where the size of each section is equal to om less than the input size of the deep learning model 1902. Then, each section may be input to the deep learning model 1902 model, and the model maps it to a vector in continuous If there is no close-by law in state space 1802, one may assume that the inputted section of the brief contains no important factual pattern relevant to any law and disregard that section.

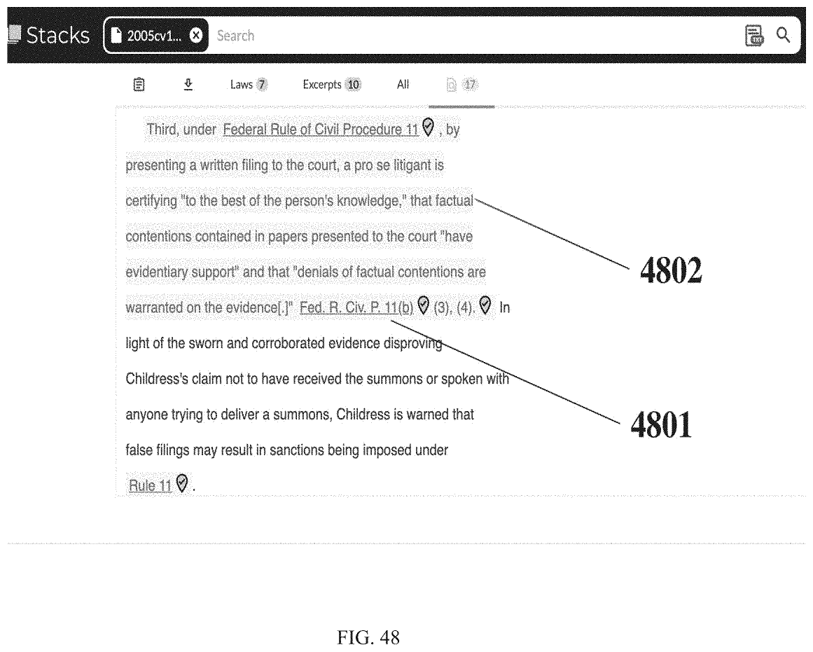

As an exemplary implementation, FIG. 48 shows a screenshot of a front end results when the user 101 uploads a brief 4701. All cited laws and important factual patterns detected by the model are highlighted and labeled by 4801 and 4802 respectively. By clicking on each highlighted area, the similar or relevant laws will be displayed to the user.

### Scaling

One of the main challenges of any data-driven system is scaling up to handle an ever-growing amount of data. This challenge is encountered in almost all conventional research systems where the search engine must go over all the records to find relevant results. ML solutions, scaling up becomes a lot easier with the system automatically learning. Furthermore, above all else lies the fact that in modern DL, scaling up and providing more data actually enhances and improves the overall performance of the system. Namely, the more the amount of data, the better becomes the performance, as depicted in FIG. 49. Although FIG. 49 is not derived from real data and processes, it correctly depicts the fact that the performance of the research system 104 disclosed in this application would increase with the addition of more data.

### Additional Applications

in this application, the focus has been on research systems for legal research. Similar systems could be used for other fields, such as scientific literature research. The records of the database 105 in scientific literature research example is composed of scientific articles which are preprocessed similarly to the techniques discussed here. The training dataset is, however, made out of the context citation pairs in which: (1) a citation refers to either a journal reference, a thesis, or any other type of scientific document or material that is cited in the body of the scientific articles; (2) a context is any text composed of a sentence Of series of sentences including, or appearing in the vicinity of the citation from a pair, which can be found using similar methods to what have been revealed in this application for the locating of legal citations. A slight difference from before in finding the scientific citations would be that generally speaking, authors cite a material using one of the common standard citation styles such as APA, MLA, Chicago, Turabian, IEEE, etc., and the in-text citing is done through indexing or the author's last name followed by the publication year. According to the style, the system to look for the in-text citations to extract their context can be adjusted. The rest of the system including the design of ML models and training them, postprocessing and presenting the final results, is identical to the legal research example.

### Speed and Cost Considerations

When implemented on the cloud, the operation cost of the system is much lower than that of conventional tools. This is because the latter requires building and maintaining extremely costly databases, and for each query, they need to perform a search and information retrieval process to return relevant documents that contain the query. In contrast, the present system's machine learning model has learned the knowledge from the database, and it directly returns the results based on its knowledge with no need to perform a costly search. As a result, it can be executed on much less expensive and simpler hardware that needs minimal maintenance. The memory footprint of the system is also smaller, and the backend is slimmer. Therefore, one server alone can handle many users simultaneously, at a cost of less than one-dollar per registered user per year performing a nominal number of search sessions.

The present system is also much faker than conventional legal search engines. Such search engines must go through their database to find similar documents. Given an input, the speed at which the trained model that is implemented on a modest CPU node returns relevant results is in the range of milliseconds.

### EXAMPLES

### Comparative Test 1

The present research system (“Platform A”) and an existing, widely-used, commercial, legal case law research tool (“Platform B”) were each used to generate results from a series of different input queries. The top ten results produced by each platform were recorded. Three law school legal scholars familiar with 4th Circuit Court of Appeals case law were given the queries and the recorded results. Each reviewer was blinded as to which platform was used to produce the results or how the results were specifically generated. Each reviewer provided subjective comments regarding the results and/or selected which platform they believed produced more relevant results overall.

Query 1: “Independent contractor started selling competing products while representing another company”

Query 1 results:

| Rank | Platform A Results | Platform B Results |
|---|---|---|
| 1 | Business Conspiracy Statute, | 15 USCS § 1125 |
| | Va. Code Ann. § 18.2-499 | |
| | (2004 & Supp. 2007) | |
| 2 | 15 U.S.C. § 15 | 15 USCS § 1 |
| 3 | N.C. Gen. Stat. § 75-1.1(a) | USCS Const. Amend. 14 |
| 4 | § 4 of the Clayton Act | 15 USCS §2 |
| 5 | 29 U.S.C. § 185(a) | Fed Rules Civ Proc R 56 |
| 6 | Valmac Indus, v. NLRB, | Major v. Orthopedic Equipment Co., |
| | 599 F.2d 246, 247, 249 | 561 F.2d 1112 |
| | (8th Cir. 1979) | |
| 7 | Lawn & Landscaping, Inc. v. | [Case unique to search engine] |
| | Smith, 542 S.E.2d 689, 693 | |
| | (N.C. Ct. App. 2001) | |
| 8 | Harrington Mfg. Co., Inc. v. Powell | N/A |
| | Mfg. Co., 248 S.E.2d 739, 746 | |
| | (N.C. Ct. App. 1978) | |
| 9 | Henderson v. Inter-Chem Coal | N/A |
| | Co., Inc., 41 F.3d 567, 570 | |
| | (10th Cir. 1994) | |
| 10 | Opsahl v. Pinehurst, Inc., | N/A |
| | 344 S.E.2d 68, 77 | |
| | (N.C. Ct. App. 1986) | |

Platform search nine selected by reviewer: Platform A.

Query 2: “Defrauding United States Treasury by forming a company to collect fake tax returns”

Query 2 results:

| Rank | Platform A Results | Platform B Results |
|---|---|---|
| 1 | 26 U.S.C. § 7206(1) | 18 USCS § 371 |
| 2 | 26 U.S.C. § 7201 | 18 USCS § 1341 |
| 3 | 26 U.S.C. § 7206(2) | 18 USCS Appx § 2B1.1 |
| 4 | 26 U.S.C. § 7203 | USCS Const. Amend. 5 |
| 5 | 18 U.S.C. § 287 | 18 USCS § 1343 |
| 6 | United States v. Aramony, | N/A |
| | 88 F.3d 1369, 1382 | |
| | (4th Cir. 1996) | |
| 7 | United States v. Wilson, | N/A |
| | 118 F.3d 228, 236 | |
| | (4th Cir. 1997) | |
| 8 | United States v. Wynn, | N/A |
| | 684 F.3d 473, 478 | |
| | (4th Cir. 2012) | |
| 9 | Neder v. United States, | N/A |
| | 527 U.S. 1, 25 (1999) | |
| 10 | United States v. Godwin, | N/A |
| | 272 F.3d 659, 666 | |
| | (4th Cir. 2001) | |

Platform search engine selected by legal scholar: Platform A.

Query 3: “A juvenile person with life sentence must be given a fair chance for release considering his age”

Query 3 results:

| Rank | Platform A Results | Platform B Results |
|---|---|---|
| 1 | 18 U.S.C. § 5032 | USCS Const. Amend. 14 |
| 2 | 18 U.S.C. § 3401(g) | USCS Const. Amend. 6 |
| 3 | 18 U.S.C. § 5031 | USCS Const. Amend. 5 |
| 4 | 18 U.S.C. § 2241(c) | 42 USCS § 1983 |
| 5 | § 4248 (d) | 28 USCS § 2254 |
| 6 | Graham v. Florida, | N/A |
| | 560 U.S. 48 (2010) | |
| 7 | Roper v. Simmons, | N/A |
| | 543 U.S. 551 (2005) | |
| 8 | LeBlanc v. Mathena, | N/A |
| | No. 2:12-CV-340, | |
| | 2015 WL 4042175 | |
| | (E.D. Va. Jul. 1, 2015) | |
| 9 | In re: Jarius Phillips | N/A |
| | (4th Cir. 2018) | |
| 10 | Begay v. United States, | N/A |
| | 553 U.S. 137, 141 (2008) | |

Platform search engine selected by legal scholar: Platform A.

Query 4: “A juvenile person with life sentence must be given a fair chance for release considering his age”

Comparative results not shown for brevity.

Platform search engine selected by legal scholar: Platform A.

### Comparative Test 2

A single query was used with one of the words replaced with its synonym to mimic the impact of natural language variations and assess how robust the results are against such variations. The altered query was then run in the two search engines, Platform A and Platform B. The results from each platform search engine were then compared to results from the respective initial search results.

Query 1: “Using territory as a nickname for religion and national origin in denying immigrants entry to the US”

Query 2: “Using territory as a synonym for religion and national origin in denying immigrants entry to the US”

### Results

| Platform A; Query 1 | Platform A; Query 2 | Platform B; Query 1 | Platform B; Query 2 |
|---|---|---|---|
| § 1152(a)(1) | § 1152(a)(1) | 42 USCS § 2000e-2 | USCS Const. Amend. 14 |
| § 1152(a)(1)(A) | § 1152(a)(1)(A) | 42 USCS § 1983 | Fed. R. Civ. P. 23 |
| 8 U.S.C. § 1182(f) | 8 U.S.C. § 1182(f) | USCS Const. Amend. 5 | Fed. R. Civ. P. 60 |
| § 1185(a)(1) | Immigration Act | USCS Const. Amend. 14 | 28 USCS 2201 |
| Immigration Act | 8 U.S.C. § 1182(f) | USCS Const. Amend. 1 | N/A. |
| | and 1185(a)(1) | | |
| Green, 360 U.S. at 507 | Green, 360 U.S. at 507 | U.S. v. Demjanjuk. | N/A |
| | | 518 F. Supp. 1362 | |
| Zadvydas, 533 U.S. at 697 | Zadvydas, 533 U.S. at 697 | N/A | N/A |
| Trump. 137 Ct. at 2088 | Trump v. Hawai'i, | N/A | N/A |
| | No. 17-965, 2018 WL | | |
| | 324357 (Jan. 19, 2018 | | |
| Trump v. Hawai'I, | Trump, 137 S. Ct. at 2088 | N/A | N/A |
| No. 17-965, 2018 WL | | | |
| 324357 (Jan. 19, 2018 | | | |
| Higuit v. Gonzales, | Verdugo-Urquidez, | N/A | N/A |
| 433 F.3d 417, 419 | 494 U.S. at 271 | | |
| (4th Cir. 2006 | | | |

Results: the change in the natural language used in the query had only minor impacts on the results obtained from the present research system (Platform A). The only notable material change was in the final, least relevant, case.

On the other hand, the change in the natural language used in the query substantially impacted the results returned by Platform B, which included fewer cases and laws, and only one result appeared consistently in both the first and second searches.

### Example 1

A machine learning model trained on case law and other legal documents involving Miranda v. Arizona, 384 U.S. 436 (1966) was used to generate results. According to one non-legal source, “Miranda v. Arizona, 384 U.S. 436 (1966), was a landmark decision of the United States Supreme Court. In a 5-4 majority, the Court held that both inculpatory and exculpatory statements made in response to interrogation by a defendant in police custody will be admissible at trial only if the prosecution can show that the defendant was informed of the right to consult with an attorney before and during questioning and of the right against self-incrimination before police questioning, and that the defendant not only understood these rights, but voluntarily waived them.” This summary of Miranda explains its implications and the precedent it set. However, relevant case law and its implications could also be learned based on its use in various other cases, such as 4th Circuit Court of Appeals decisions/opinions. Note that it is virtually impossible to create a formal definition for every case decision or distill a statute into a simple definition and maintain a table that assigns laws to different keywords or issues. There are too many laws, each law can have multiple rules drawn from it, more laws are constantly being added, the implications and the precedent set by a law can change or evolve over time, and the patterns associated with laws could be very subtle and exist in a very high dimensional space.

Here, the training dataset included multiple examples of the Miranda decision applied in various contexts by the 4th Circuit Court of Appeal, including those listed below (specific case citations omitted):

“Seabrook first contests the voluntariness of his statements made to law enforcement officers on the ground that they were taken by investigators in violation of Miranda v. Arizona, 384 U.S. 436 (1966).”

“A defendant's statements during custodial interrogation are presumptively compelled in violation of the Fifth Amendment and are inadmissible unless the Government shows that law enforcement officers informed the defendant of his rights pursuant to Miranda v. Arizona, 384 U.S. 436 (1966), and obtained a waiver of those rights.”

“The district court also properly denied McElveen's motion to suppress statements made to police because McElveen had waived his rights under Miranda v. Arizona, 384 U.S. 436 (1966).”

“Statements obtained from a defendant during custodial interrogation are admissible only if the Government shows that law enforcement officers adequately informed the defendant of his rights under Miranda v. Arizona, 384 U.S. 436 (1966). and obtained a waiver of those rights.”

“At the start of the interview, the officers informed Henley of his rights under Miranda v. Arizona, 384 U.S. 436 (1966), and Henley signed a form waiving those rights.”

The trained model learns the factual patterns associated with each law using the decisions like those listed above. Whenever it observes the same patterns in a user's query, it returns the associated laws with that pattern.

Query: “confess under interrogation”

Result: Miranda v. Arizona, 384 U.S. 435 (1966) is outputted as one of the most relevant cases for this inquiry because the model has learned from the knowledge in the above and other court opinions that the court applies this case law when making decisions on the merits of statements received from defendants in custody. In returning the results, none of the specific opinions/decision case law files are specifically searched (as previously explained).

### Example 2

Trained model as described herein.

Query: “a juvenile person with life sentence must be given a fair chance for release considering his age.”

Results: the research system receives this query, extracts important factual patterns in this query, and produces the following results:

18 U.S.C. § 5032 (describes procedures for criminal prosecution of juveniles);

18 U.S.C. § 3401(g) (relates to juveniles charged with serious offenses);

18 U.S.C. § 5031 (defines who is/are juveniles);

Graham v. Florida, 560 U.S. 48 (2010) (landmark case for harsh punishments against juveniles).

We claim:

1. A non-transitory computer storage medium encoded with a computer program having instructions that when executed by one or more data processing apparatus causes the apparatus to perform operations comprising:
receiving a user input from a human-computer interface device;
processing the input in an input processing device, wherein the input processing device includes a machine learning model previously trained on a dataset, wherein the dataset includes a plurality of records each containing information about a topic, and wherein the trained model's network architecture and parameters establish its knowledge of the topic; and
displaying a result from the input processing device responsive to the input using the trained model without directly searching any one of the plurality of records.

2. The program of claim 1, further comprising, when the input comprises textual data inputted by the user or uploaded as a data file:
producing a feature vector representation of all or a portion of the textual data;
inputting the feature vector as input to the trained model to obtain an output vector, wherein the model is previously trained on at least a portion of the dataset having at least a set of one or more legal statutes, regulations, rules, case docket filings, and court opinions applicable to a predetermined jurisdiction;
identifying one or more similarity measures between the input and one or more portions of the dataset using at least the output vector, wherein calculating the similarity measures does not include searching the dataset to identify a presence of a keyword or synonym of a keyword obtained from the textual data input; and
displaying via the human-computer interface a ranked list of information from the dataset responsive to the input based on the similarity measures.

3. The program of claim 2, wherein the one or more portions of the dataset are represented by one or more respective word vectors, and wherein calculating the similarity measures comprises calculating a distance between the feature vector and each of the one or more word vectors.

4. The program of claim 3, wherein each of the similarity measures is a cosine similarity distance or a Levenshtein distance between the output vector and each of the one or more word vectors.

5. The program of claim 2, wherein producing the feature vector comprises preprocessing the textual data input to remove a portion of the textual data or add new information to the textual data.

6. The program of claim 2, wherein the ranked list is determined using a predefined threshold value as a cut-off for comparison to the similarity measures, and wherein displaying comprises selecting the one or more word vectors having a similarity measure above the threshold value.

7. The program of claim 1, further comprising a human-computer interface, wherein the human-computer interface is one of a graphical user interface or a voice-enabled digital assistant device operable on one or more of a desktop computer, a laptop computer, a smart phone, a wearable device, and an edge device; and wherein the data processing apparatus comprises one of a cloud computer, a remote computer on a wide area network, a remote computer on a local area network, a user's personal computer, or a consumer edge device; and wherein transmitting the input to an input processing device comprising using an application programming interface.

8. The program of claim 1, wherein the dataset is selected from a corpus of legal documents and the topic is an application of laws to a set of facts.

9. A process implemented using one or more data processing apparatus comprising:
receiving a user input from a human-computer interface device;
transmitting the input to an input processing device, wherein the input processing device includes a machine learning model previously trained on a dataset, wherein the dataset includes a plurality of records each containing information about a topic, and wherein the trained model's network architecture and parameters establish its knowledge of the topic; and
displaying a result responsive to the input by processing the input using the trained model without directly searching any one of the plurality of records.

10. The process of claim 9, further comprising, when the input comprises textual data inputted by the user or uploaded as a data tile:
producing a feature vector representation of all or a portion of the textual data;
inputting the feature vector as input to the trained model to obtain an output vector, wherein the model is previously trained on at least a portion of the dataset having at least a set of one or more legal statutes, regulations, rules, case docket filings, and court opinions applicable to a predetermined jurisdiction;
identifying one or more similarity measures between the input and one or more portions of the dataset using at least the output vector, wherein calculating the similarity measures does not include searching the dataset to identify a presence of a keyword or synonym of a keyword obtained from the textual data input; and displaying via the human-computer interface a ranked list of information from the dataset responsive to the input based on the similarity measures.
receiving from a human-computer interface device an input from a user comprising textual data;
producing a feature vector representation of all or a portion of the textual data;
inputting the feature vector as input to a machine learning model to obtain an output vector, wherein the model is previously trained on at least a portion of a dataset having at least a set of one or more legal statutes, regulations, rules, case docket filings, and court opinions applicable to a predetermined jurisdiction;
identifying one or more similarity measures between the user's textual data and one or more portions of the dataset using at least the output vector, wherein calculating the similarity measures does not include searching the dataset to identify a presence of a keyword or synonym of a keyword obtained from the user's textual data input; and
displaying via the human-computer interface device a ranked list of information from the dataset responsive to the user's input data based on the similarity measures.

11. The process of claim 10, wherein the one or more portions of the dataset are represented by one or more respective word vectors, and wherein calculating the similarity measures comprises calculating a distance between the feature vector and each of the one or more word vectors.

12. The process of claim 11, wherein each of the similarity measures is a cosine similarity distance or a Levenshtein distance between the output vector and each of the one or more word vectors.

13. The process of claim 10, wherein producing the feature vector comprises preprocessing the textual data input to remove a portion of the textual data or add new information to the textual data.

14. The process of claim 10, wherein the textual data inputted by the user is provided in the form of a data file.

15. The process of claim 10, wherein the ranked list is determined using a predefined threshold value as a cut-off for comparison to the similarity measures, and wherein displaying comprises selecting the one or more word vectors having a similarity measure above the threshold value.

16. The process of claim 10, further comprising:
preprocessing a plurality of records of the dataset to identify different forms of a citation to a law; and
replacing the different forms with a single selected form.

17. The process of claim 16, further comprising:
based on the textual data input, identifying from among the plurality of records those that include a citation to a different one of the plurality of records;
identifying an excerpt from one of the identified records; and
outputting the result including the identified excerpt.

18. The process of claim 9, further comprising:
programming at least one machine learning network and selecting an associated initial set of hyperparameters for constructing the machine learning model;
extracting from the dataset a plurality of records each containing information about the topic for use as a training dataset;
training the machine learning network using the training dataset until a final set of hyperparameters is identified that, when used to test a testing dataset comprising a plurality of records containing information about the topic, causes the machine learning model to produce an output result satisfying one or more predetermined criteria.

19. The process of claim 18, further comprising:
training more than one different machine learning networks using the training dataset; and
classifying the outputs from each of the trained machine learning models using a nearest neighbor computation to identify a best result from among the output results.
